(19) United States
(12) Patent Application Publication
(10) Pub. No.: US 2024/0103768 A1
(43) Pub. Date: Mar. 28, 2024

(54) STORAGE SYSTEM, STORAGE APPARATUS, AND STORAGE METHOD

(71) Applicant: Kioxia Corporation, Tokyo (JP)

(72) Inventor: Haruhiko AKIYAMA, Koganei Tokyo (JP)

(21) Appl. No.: 18/458,757

(22) Filed: Aug. 30, 2023

(30) Foreign Application Priority Data
Sep. 22, 2022 (JP) 2022-151324

(51) Int. Cl. G06F 3/06

(52) U.S. Cl. CPC G06F 3/0659; G06F 3/0658; G06F 3/0607; G06F 3/0679

(57) ABSTRACT

A storage system includes a storage apparatus that includes a storage circuit storing key-value data including a key-value pair, and a controller, a host apparatus connected to the storage apparatus and a recording medium. The host apparatus transmits a first command and input data including first information to the controller. In response to the first command, the controller updates the first information to generate second information, reads the key-value data from the storage circuit, generates output data including the key-value data and the second information associated with the key-value data, and transmits the output data to the host apparatus. The host apparatus stores the output data into the recording medium.

### CROSS-REFERENCE TO RELATED APPLICATION(S)

This application is based upon and claims the benefit of priority from Japanese Patent Application No. 2022-151324, filed Sep. 22, 2022, the entire contents of which are incorporated herein by reference.

### FIELD

Embodiments described herein relate generally to a storage system, a storage apparatus, and a storage method.

### BACKGROUND

Storage apparatuses capable of storing data in nonvolatile manner are known. Storage apparatuses and host apparatuses controlling the storage apparatuses are provided in storage systems. In recent years, storage systems to which key-value storing methods of processing key-value pairs are applied have been proposed. In such storage systems, storage apparatuses store key-value pairs. Functions of backing up key-value pairs stored by the storage apparatuses have been proposed.

### DESCRIPTION OF THE DRAWINGS

FIG. 1 is a block diagram illustrating a hardware configuration of a storage system according to a first embodiment;

FIG. 2 is a diagram illustrating a functional block of the storage system according to the first embodiment;

FIG. 3 is a diagram illustrating details of input data and output data by a list command according to the first embodiment;

FIG. 4 is a diagram illustrating details of input data by a list store command according to the first embodiment;

FIG. 5 is a sequence diagram illustrating operations, and transmission and reception of commands and signals between a host apparatus and a key-value persistent storage apparatus in a full backup operation according to the first embodiment;

FIG. 6 is a sequence diagram illustrating operations, and transmission and reception of commands and signals between the host apparatus and the key-value persistent storage apparatus in a differential backup operation according to the first embodiment;

FIG. 7 is a sequence diagram illustrating operations, and transmission and reception of commands and signals between the host apparatus and the key-value persistent storage apparatus in a restoring operation according to the first embodiment;

FIG. 8 is a block diagram illustrating a configuration of a storage system according to a second embodiment;

FIG. 9 is a block diagram illustrating a connection example between a host apparatus and a key-value persistent storage apparatus according to the second embodiment;

FIG. 10 is a diagram illustrating request content when a request is issued from the host apparatus to the key-value persistent storage apparatus according to the second embodiment;

FIG. 11 is a diagram illustrating a method of mapping a user key and a storage destination to a NAND flash memory by a mapping processing unit according to the second embodiment;

FIG. 12 is a sequence diagram illustrating operations, and transmission and reception of commands and signals between the host apparatus and the key-value persistent storage apparatus in a full backup operation according to the second embodiment;

FIG. 13 is a sequence diagram illustrating operations, and transmission and reception of commands and signals between the host apparatus and the key-value persistent storage apparatus in a differential backup operation according to the second embodiment;

FIG. 14 is a sequence diagram illustrating operations, and transmission and reception of commands and signals between the host apparatus and the key-value persistent storage apparatus in a restoring operation according to the second embodiment;

FIG. 15 is a diagram illustrating a functional block of a storage system according to a third embodiment;

FIG. 16 is a sequence diagram illustrating operations, and transmission and reception of commands and signals between a host apparatus and a key-value persistent storage apparatus in a full backup operation according to the third embodiment;

FIG. 17 is a sequence diagram illustrating operations, and transmission and reception of commands and signals between the host apparatus and the key-value persistent storage apparatus in a differential backup operation according to the third embodiment;

FIG. 18 is a sequence diagram illustrating operations, and transmission and reception of commands and signals between the host apparatus and the key-value persistent storage apparatus in a restoring operation according to the third embodiment; and

FIG. 19 is a sequence diagram illustrating operations, and transmission and reception of commands and signals between a host apparatus and a key-value persistent storage apparatus in a restoring operation according to a fourth embodiment.

### DETAILED DESCRIPTION

Embodiments provide a storage system, a storage apparatus, and a storage method capable of backing up key-value pairs appropriately.

In general, according to at least one embodiment, a storage system includes: a storage apparatus including a storage circuit configured to store first key-value data including a key-value pair which has a key and a value associated with the key and a controller configured to control the storage circuit; a host apparatus connected to the storage apparatus and a recording medium. The host apparatus is configured to transmit a first command and first input data including first information to the controller. In response to reception of the first command, the controller is configured to update the first information to generate second information, the second information being associated with the first key-value data, read the first key-value data from the storage circuit, generate first output data including the read first key-value data and the generated second information, and transmit the first output data to the host apparatus. The host apparatus is configured to store the first output data into the recording medium.

Hereinafter, embodiments will be described with reference to the drawings. In the following description, common reference numerals are given to elements that have the same functions and configurations. In embodiments to be described below, apparatuses or methods for embodying technical spirits of the embodiments are exemplified and materials, shapes, structures, disposition, and the like of the elements are not identified as the specific followings.

Functional blocks may be implemented by one of hardware and computer software or a combination thereof. It is not essential to distinguish the functional blocks from each other as the following examples. For example, some of the functions may be implemented by functional blocks different from the functional blocks. The functional blocks may be further divided into detailed functional sub-blocks.

In recent years, an amount of information accumulated in a storage has exponentially increased, and a database has generally been used to utilize and manage data safely and efficiently. In a relational database which is a type of database which has been widespread at present, a new database typified by a key-value store is used as a data store in some cases. The key-value store is a data store that includes a pair of key and value associated with the key as a data structure. In the key-value store, when a key is provided, a value associated with this key can be acquired. Thereafter, the pair of key and value associated with the key is referred to as a key-value pair.

“NVM Express Key Value Command Set Specification” is disclosed as a command specification of “NVM Express Base Specification, Revision 2.0a”. Hereinafter, a standard defined in “NVM Express Key Value Command Set Specification” is also referred to as a key-value standard.

### 1. First Embodiment

A storage system according to a first embodiment will be described. The storage system provides a method of storing (or copying) a key-value pair stored in a key-value persistent storage apparatus as backup data (a backup operation) and a method of efficiently restoring the key-value pair stored as backup data again in the key-value persistent storage apparatus (a restoring operation).

As the backup operation, two types of backup operations, that is, a full backup operation of backing up all key-value pairs in a key-value persistent storage apparatus and a differential backup operation of backing up only key-value pairs of which values are updated (added, changed, or erased) from a designated past backup time, are provided. The full backup operation is implemented by recording version information of key-value pairs in the key-value persistent storage apparatus when a backup operation is started and acquiring a list of the key-value pairs of the designated version information. The differential backup operation is implemented by acquiring a list of key-value pairs having keys updated between designated versions. Further, the restoring operation is implemented by collecting the list of the key-value pairs acquired in the backup operation and writing the list of the key-value pairs to the key-value persistent storage apparatus.

1.1 Configuration of Storage System

First, a configuration of a storage system according to a first embodiment will be described.

1.1.1 Hardware Configuration

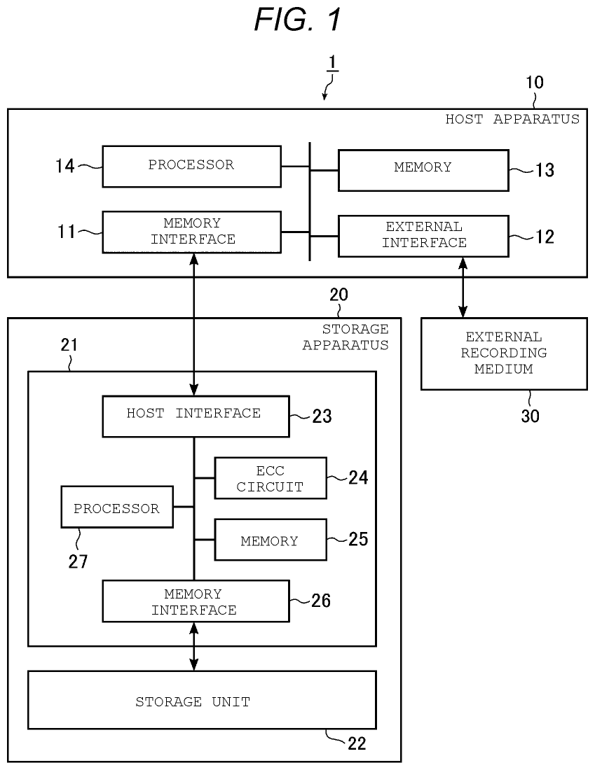

FIG. 1 is a block diagram illustrating a hardware configuration of a storage system according to the first embodiment.

A storage system 1 includes a host apparatus 10, a key-value persistent storage apparatus 20, and an external recording medium 30. In the storage system 1, the key-value persistent storage apparatus 20 can execute various operations in response to commands from the host apparatus 10. In the storage system 1, for example, the key-value pairs stored in the key-value persistent storage apparatus 20 are read in response to commands from the host apparatus 10, and the read key-value pairs are stored as backup data into the external recording medium 30. In the storage system 1, key-value pairs stored in the external recording medium 30 are also read in response to commands from the host apparatus 10 and are written back to the key-value persistent storage apparatus 20. Thereafter, the key-value persistent storage apparatus 20 is simply referred to as the storage device 20.

The host apparatus 10 includes a memory interface 11, an external interface 12, a memory 13, and a processor (or a central processing unit (CPU)) 14.

The memory interface 11 is connected to the storage apparatus 20 via a host bus to communicate with the storage apparatus 20. For example, the memory interface 11 transmits data received from the storage apparatus 20 to the memory 13. The memory interface 11 transmits data in the memory 13 to the storage apparatus 20 in response to a command from the processor 14.

The external interface 12 is connected to the external recording medium 30 via a bus to communicate with the external recording medium 30. For example, the external interface 12 transmits data in the memory 13 to the external recording medium 30 in response to a command from the processor 14. The external interface 12 transmits data received from the external recording medium 30 to the memory 13.

The memory 13 temporarily stores firmware to be executed by the host apparatus 10, various management tables, data, and the like. The memory 13 is used as a work area of the processor 14. The memory 13 is, for example, a semiconductor memory such as a dynamic RAM (DRAM) or a static RAM (SRAM).

The processor 14 controls the entire host apparatus 10. For example, the processor 14 controls operations of the memory interface 11, the external interface 12, and the memory 13.

The storage apparatus 20 includes a memory controller 21 and a storage unit 22. The storage apparatus 20 is connected to the host apparatus 10 and can execute various operations in response to commands from the host apparatus 10.

The memory controller 21 includes a host interface 23, an error checking and correction (ECC) circuit 24, a memory 25, a memory interface 26, and a processor (or a CPU) 27.

The host interface 23 is connected to the host apparatus 10 via the host bus to communicate with the host apparatus 10. For example, the host interface 23 transmits commands and data received from the host apparatus 10 to the processor 27 and the memory 25.

The ECC circuit 24 executes a process related to error detection and correction on write data to be written to the storage apparatus 20 and read data to be read from the storage apparatus 20. Specifically, the ECC circuit 24 generates redundant data (parity) for correcting an error of write data to be written to the storage apparatus 20. The generated redundant data and the write data are written to the storage apparatus 20. Therefore, data read from the storage apparatus 20 includes write data and a parity corresponding to the write data. The ECC circuit 24 detects an error in data read from the storage apparatus 20 by using the write data and the parity and corrects the error when there is the error.

The memory 25 temporarily stores firmware to be executed in the storage apparatus 20, various management tables, data, and the like. The memory 25 is used as a work area of the processor 27. The memory 25 is, for example, a semiconductor memory such as a DRAM or an SRAM.

The memory interface 26 is connected to the storage unit 22 via a memory bus to communicate with the storage unit 22. The memory interface 26 transmits various signals, commands, and data to the storage unit 22 based on commands received from the processor 27. The memory interface 26 receives various signals and data from the storage unit 22.

The processor 27 controls the entire storage apparatus 20. For example, the processor 27 controls operations of the host interface 23, the ECC circuit 24, the memory 25, and the memory interface 26.

The storage unit 22 stores data in a nonvolatile manner. The storage unit 22 includes, for example, a NAND flash memory. As the storage unit 22, a memory other than a NAND flash memory may be used.

The external recording medium 30 is a storage apparatus connected to the host apparatus 10 and is a storage apparatus other than the storage apparatus 20. The external recording medium 30 may be, for example, a solid-state drive (SSD) or a hard disk drive (HDD) or may be a key-value persistent storage apparatus other than the storage apparatus 20.

1.1.2 Configuration of Functional Block

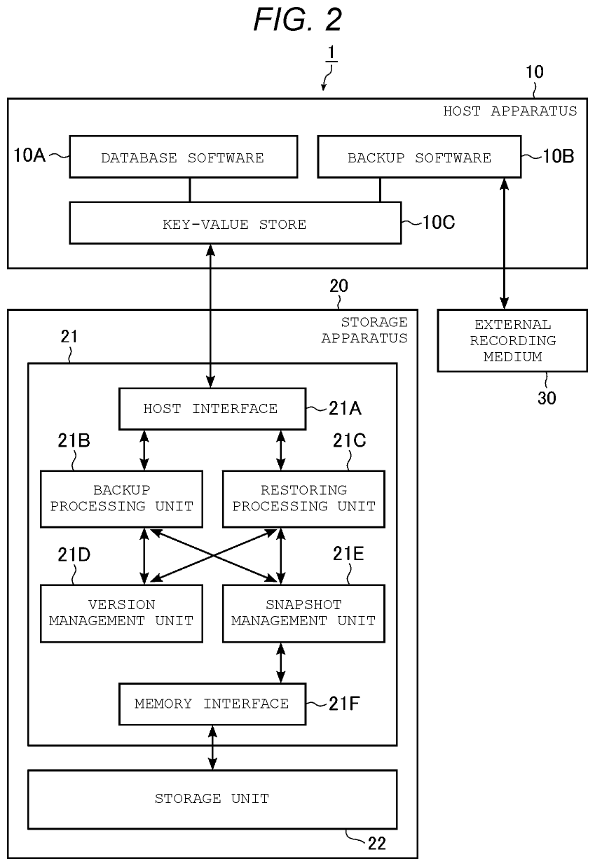

FIG. 2 is a diagram illustrating a functional block of the storage system according to the first embodiment. The storage system 1 includes the host apparatus 10, the storage apparatus 20, and the external recording medium 30. The storage system 1 is an example in which a key-value store 10C is adopted as a data store of a database system and the storage apparatus 20 is adopted as a storage.

The host apparatus 10 includes database software 10A, backup software 10B, and a key-value store 10C. The host apparatus 10 manages data such as an application handled by a user in the host apparatus 10 by using the database software 10A. The host apparatus 10 executes a backup operation of generating a backup of data stored by the database software 10A by using the backup software 10B. The key-value store 10C is a store that is used as a data store of a database. The key-value store 10C is a store in which key-value pairs are provided as a data structure. In the present specification, the key-value store 10C has also a function as an interface of controlling of transmitting and receiving commands, data, and signals.

The storage apparatus 20 is a persistent storage apparatus that has a key-value interface. The storage apparatus 20 includes a memory controller 21 and a storage unit 22. The memory controller 21 includes a host interface 21A, a backup processing unit 21B, a restoring processing unit 21C, a version management unit 21D, a snapshot management unit 21E, and a memory interface 21F.

The host interface 21A executes reception of a command and an internal process in the storage apparatus 20. The backup processing unit 21B executes a backup operation for a key-value pair according to the embodiment. The backup processing unit 21B reads a key-value pair stored in the storage apparatus 20 as backup data. The restoring processing unit 21C executes a restoring operation on the key-value pair according to the embodiment. The restoring processing unit 21C writes back the backup data (the key-value pairs) backed up in the backup operation. The version management unit 21D manages a version indicating a generation of the key in the key-value pair written to the storage apparatus 20. The snapshot management unit 21E manages the key-value pair for each generation of the key. The memory interface 21F corresponds to the memory interface 26 illustrated in FIG. 1.

The external recording medium 30 is a storage apparatus connected to the host apparatus 10 and is a storage apparatus different from the storage apparatus 20. The external recording medium 30 stores the key-value pair stored in the storage apparatus 20 as backup data in accordance with the backup software 10B. The external recording medium 30 is an apparatus that has a function of storing any binary data and may be a computer system or a network storage connected to a network together with the host apparatus 10.

1.2 Operation of Storage System

A backup operation and a restoring operation in the storage system 1 according to the first embodiment will be described.

The backup operation is an operation of reading the key-value pair stored in the storage apparatus 20 and storing the key-value pair into a storage apparatus (for example, the external recording medium 30) connected to the host apparatus 10 or a memory (for example, the memory 13) provided in the host apparatus 10. The backup operation includes the full backup operation and the differential backup operation, as described above.

The restoring operation is an operation of writing the key-value pair stored as the backup data in the storage apparatus connected to the host apparatus 10 or the memory provided in the host apparatus 10 back to the storage apparatus 20. Here, it is assumed in description that the key-value pair is stored as backup data in the external recording medium 30 in the backup operation and the key-value pair stored in the external recording medium 30 is written back to the storage apparatus 20 in the restoring operation.

Before the backup operation and the restoring operation are described, an extended list command issued from the key-value store 10C of the host apparatus 10 to the storage apparatus 20 in the backup operation will be described. The extended list command is different from a list command defined in the key-value standard. The extended list command is a command that has an extension function of giving a command to execute the full backup operation or the differential backup operation and acquiring a list of the key-value data including the key-value pairs. Here, the list is data including the key-value data. Hereinafter, the extended list command used in the first embodiment and a third embodiment is simply referred to as a list command. A list command used in a second embodiment is a command defined in the key-value standard.

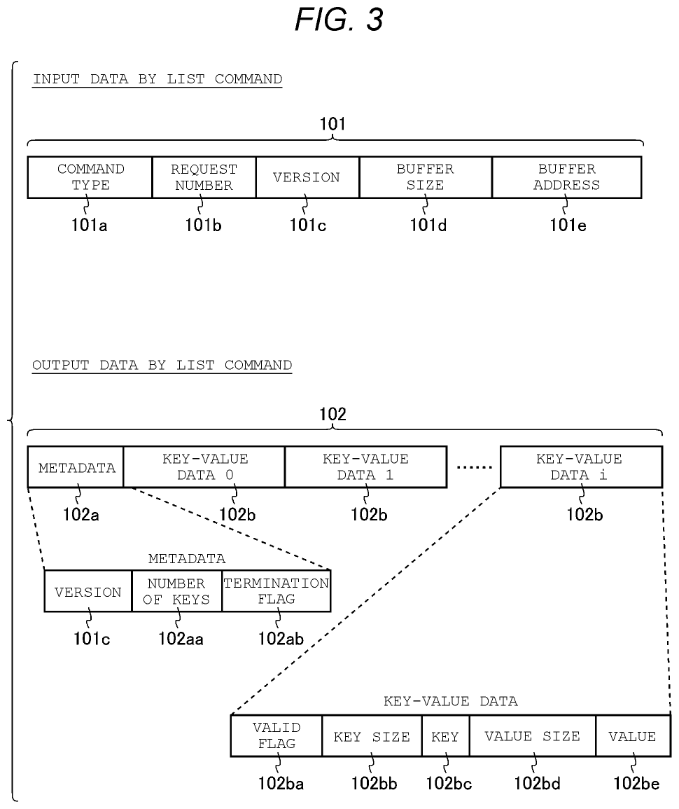

Hereinafter, details of input data and output data by the list command will be described. FIG. 3 is a diagram illustrating the details of the input data and the output data by the list command.

When the list command is issued from the key-value store 10C to the storage apparatus 20, input data 101 is transmitted along with the list command to the storage apparatus 20. The input data 101 includes a command type 101a, a request number 101b, a version 101c, a buffer size 101d, and a buffer address 101e. The request number 101b of the input data 101 issued from the key-value store 10C includes an initial value of the request number 101b or a request number 101b provided in a response to a previously issued list command.

The command type 101a includes a value indicating one operation executed with the list command among a plurality of operations for giving a command to the storage apparatus 20. The command type 101a includes, for example, a value indicting either the full backup operation or the differential backup operation.

The request number 101b is any value uniquely determined in the storage apparatus 20 when the backup operation is started in response to reception of the list command. The request number 101b is issued from the backup processing unit 21B when the backup operation is started. The request number 101b is used to specify the same backup operation or the list command issued in the same backup operation when the list command is issued a plurality of times in one backup operation. As the request number 101b, for example, a time, a value counted whenever the list command is received, or the like is used.

The version 101c is issued from the version management unit 21D when the backup operation is started in response to the reception of the list command. The version 101c includes a value for determining a generation of the key of the key-value pair stored by the storage apparatus 20. As the version 101c, a time, a value counted whenever the list command is received, or the like is used.

The buffer address 101e is an address of a buffer guaranteed in the key-value store 10C in order to store a list of the key-value data transmitted from the storage apparatus 20 during the backup operation. The buffer size 101d is a storage capacity of the guaranteed buffer.

A data amount of the key-value data which is a backup operation target (hereinafter referred to as a backup target) in the storage apparatus 20 is assumed to be greater than the buffer size 101d prepared in the host apparatus 10. Therefore, by repeatedly transmitting the list command and acquiring the backup target by the buffer size 101d, it is possible to acquire all the key-value data of the backup target.

Next, the output data 102 by the list command will be described. When the list command is issued from the key-value store 10C to the storage apparatus 20, the output data 102 is output from the storage apparatus 20 to the key-value store 10C in response to the list command.

The output data 102 includes one piece of metadata 102a and one piece or a plurality of pieces of key-value data 102b.

The metadata 102a includes a version 101c, the number of keys 102aa, and a termination flag 102ab. The version 101c is the same as the version 101c of the input data 101. That is, the version 101c issued from the version management unit 21D during reception of the list command is provided in the metadata 102a of the output data 102 and the input data 101 corresponding to a subsequent list command. The number of keys 102aa indicates the number of keys provided in the output data 102. The termination flag 102ab is a flag indicating whether the output data 102 is final data of the backup operation output in response to the list command.

The key-value data 102b includes a key-value pair, that is, information regarding a pair of a value and a key. Specifically, the key-value data 102b includes a valid flag 102ba, a key size 102bb, a key 102bc, a value size 102bd, and a value 102be. The valid flag 102ba indicates whether the key 102bc is valid. The key size 102bb indicates a size (that is, a data amount) of the key 102bc. The key 102bc indicates the actual data of key 102bc. The value size 102bd indicates a size (that is, a data amount) of the value 102be. The value 102be indicates the actual data of value.

Next, before the restoring operation is described, a list store command issued from the key value store 10C of the host apparatus 10 to the storage apparatus 20 in the restoring operation will be described. The list store command is a command for storing the key-value pair into the storage apparatus 20 in accordance with the list of the key-value data 102b.

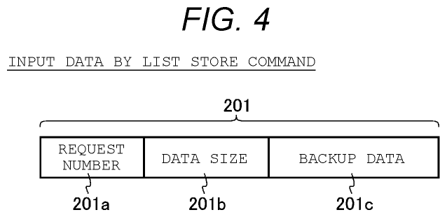

FIG. 4 is a diagram illustrating details of input data by a list store command.

When the list store command is issued from the key-value store 10C to the storage apparatus 20, input data 201 is input to the storage apparatus 20 along with the list store command. The input data 201 includes a request number 201a, a data size 201b, and backup data 201c. The request number 201a of the input data 201 issued from the key value store 10C includes an initial value of the request number 201a or the request number 201a provided in response to the previously issued list store command.

The request number 201a is issued from the backup processing unit 21B when the restoring operation is started. The request number 201a is used to specify the same restoring operation or the list store command issued in the same restoring operation when the list store command is issued a plurality of times in one restoring operation. As the request number 201a, for example, a time, a value counted whenever the list command is received, or the like is used. The backup data 201c includes the key-value data 102b which is a restoring operation target. The backup data 201c corresponds to the output data 102 backed up to the external recording medium 30 through the backup operation. That is, the backup data 201c is data in which the key-value data 102b backed up to the external recording medium 30 is read to the key-value store 10C. The data size 201b is a size (that is, a data amount) of the backup data 201c transmitted with the list store command.

When the backup data 201c which is a restoring operation target is stored in the memory of the host apparatus 10, an address on the memory of the host apparatus 10 may be designated instead of transmitting the backup data 201c to the storage apparatus 20 with the list store command, and the backup data 201c may be transmitted from the host apparatus 10 to the storage apparatus 20 by a method of accessing the address using direct memory access. As the backup data 201c, the same data structure as the data structure of the output data 102 of the list command may be used.

In the list command used in the embodiment, an input and an output are uniquely defined unlike definition of the key-value standard. When similar input/output information can be input and output between the host apparatus 10 and the storage apparatus 20, a different method may be used for the data structure or the input/output method. The list store command used in the embodiment is a uniquely proposed command which is not present in the interface defined in the key-value standard. When the key-value data 102b can be input to the storage apparatus 20, the command itself may have a different format.

1.2.1 Full Backup Operation

The full backup operation in the storage system 1 according to the first embodiment will be described. The full backup operation is an operation of storing (or copying) all the key-value data 102b stored in the storage apparatus 20 as backup data into the external recording medium 30 (or the memory 13 of the host apparatus 10).

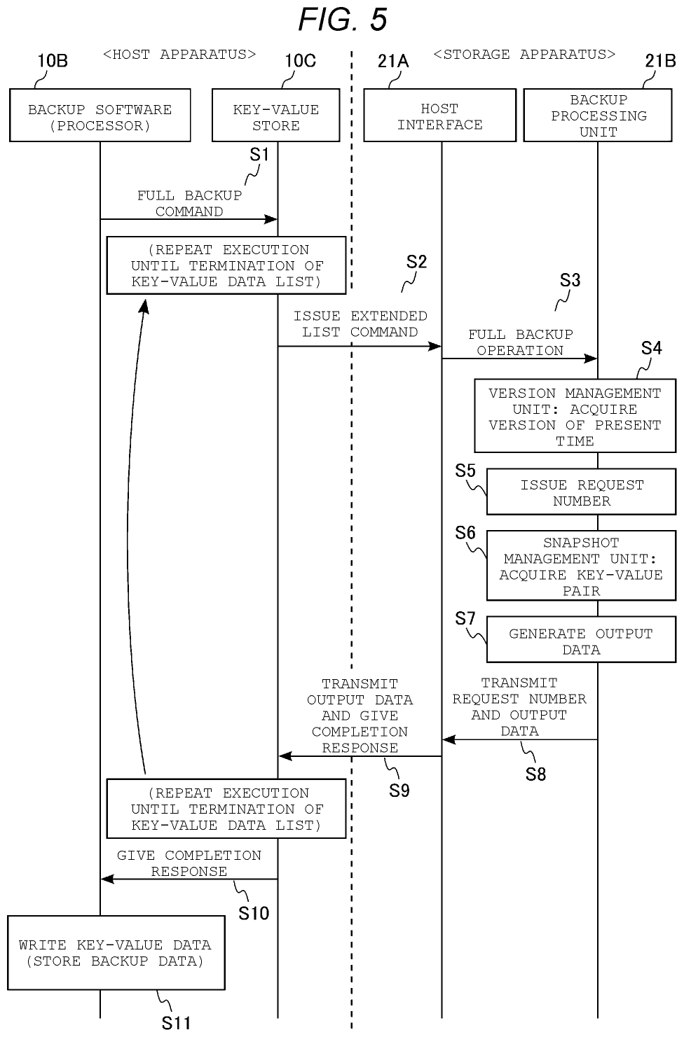

FIG. 5 is a sequence diagram illustrating operations, and transmission and reception of commands and signals between the host apparatus 10 and the storage apparatus 20 in the full backup operation according to the first embodiment. Here, an example in which the backup data (the key-value data 102b) is stored into the external recording medium 20 will be described.

The processor 14 of the host apparatus 10 reads the backup software 10B and executes the following full backup operation based on the backup software 10B.

The processor 14 of the host apparatus 10 transmits a full backup command to the key-value store 10C (S1). With the full backup command, a command to execute the full backup operation is given to the key-value store 10C. The full backup command is further used to designate a buffer address and a buffer size. The buffer address is an address of a buffer of the host apparatus 10 temporarily storing the key-value data 102b of a backup target read from the storage apparatus 20. The buffer size is a data size by which the buffer of the host apparatus 10 can store the key-value data 102b of the backup target. The key-value data 102b of the backup target is transmitted from the storage apparatus 20 to the buffer of the host apparatus 10.

When the full backup command is received, the key-value store 10C issues the list command to the storage apparatus 20 (S2). Specifically, the key-value store 10C transmits the input data 101 illustrated in FIG. 3 to the storage apparatus 20 along with the list command. As described above, the input data 101 includes the command type 101a, the request number 101b, the version 101c, the buffer size 101d, and the buffer address 101e.

In the command type 101a, here, a value indicating the full backup operation is set. In the request number 101b, a predetermined initial value (for example, 0 or the like) is set in an initial stage of the full backup operation. The version 101c of the input data 101 is any value in the full backup operation. The buffer address 101e is a buffer address designated with the full backup command and is a buffer address of the host apparatus 10 storing the key-value data 102b of the backup target. The buffer size 101d is a data size by which the buffer designated with the buffer address 101e can be stored.

When the list command is received, the host interface 21A in the storage apparatus 20 gives a command to execute the full backup operation to the backup processing unit 21B based on the received list command and the input data 101 (S3).

The backup processing unit 21B generates the request number 101b and the version 101c based on the input data 101. When the request number 101b is an initial value, the version management unit 21D acquires the version 101c of the present time (S4) and the backup processing unit 21B further newly issues the request number 101b (S5). The backup processing unit 21B stores the version 101c of the present time and the request number 101b until the full backup operation is completed.

Subsequently, the backup processing unit 21B supplies the version 101c of the present time to the snapshot management unit 21E. The snapshot management unit 21E acquires the key-value pairs in the version 101c of the present time (S6). That is, the snapshot management unit 21E reads the key-value data 102b including the key-value pairs in the version 101c of the present time from the storage unit 22. In the full backup operation, the snapshot management unit 21E acquires all the valid key-value pairs in the version 101c of the present time. Specifically, only the key-value data 102b in which the valid flag 102ba is set with a value indicating validity is acquired.

Subsequently, the backup processing unit 21B generates the output data 102 using the acquired key-value data 102b, the input data 101 received together with the list command, and the version 101c acquired in (S4) (S7). The output data 102 includes a list of the key-value data 102b corresponding to the buffer size 101d designated in the input data 101 and the metadata 102a. The metadata 102a includes the number of keys 102aa, the termination flag 102ab, and the version 101c.

Subsequently, the backup processing unit 21B transmits the generated output data 102 and the request number 101b issued in (S5) to the host interface 21A (S8). At this time, the backup processing unit 21B stores the version 101c and the key 102bc of the final key-value data 102b in the transmitted output data 102, and the transmitted request number 101b.

Subsequently, the host interface 21A sets a transmission destination at the buffer address 101e and transmits the output data 102 to the key-value store 10C. After the transmission, the host interface 21A responds to the key-value store 10C with a completion response to the list command (S9). The completion response includes the stored request number 101b.

After the completion response is received, the key-value store 10C of the host apparatus 10 checks the termination flag 102ab in the output data 102 and determines whether the received output data 102 is final output data.

When the output data 102 is not the final output data, the above-described processes from S2 to S9 are repeatedly executed until the key-value store 10C receives the final output data 102, that is, until the output data 102 in which a value indicating the end is set in the termination flag 102ab is received.

More specifically, the key-value store 10C issues the list command and the input data 101 to the storage apparatus 20 again (S2). At this time, the key-value store 10C sets the request number 101b received with the completion response in the request number 101b of the input data 101 corresponding to the list command to be issued. When the input data 101 in which the request number 101b is set is received, the backup processing unit 21B does not acquire the new request number 101b and does not acquire the new version 101c. The backup processing unit 21B checks the request number 101b and the version 101c stored in (S8), and the key 102bc of the final key-value data 102b based on the received input data 101. The backup processing unit 21B continuously generates the output data 102 including the key-value data 102b of the key 102bc continuing from the key 102bc of the final key-value data 102b and transmits the output data 102 to the host interface 21A.

When all the key-value data 102b in the version 101c stored at the start of the full backup operation is read, the backup processing unit 21B sets a value indicating an end in the termination flag 102ab of the metadata 102a in the output data 102. Here, the backup processing unit 21B may erase (clear or invalidate) information stored in the full backup operation, that is, the request number 101b, the version 101c, and the key 102bc of the final key-value data 102b in the finally responded output data 102. The host interface 21A transmits the output data 102 in which the value indicating the end is set in the termination flag 102ab to the key-value store 10C and responds to the key-value store 10C a completion response with respect to the list command after the transmission (S9). In this way, the above-described processes from S2 to S9 are repeatedly executed until the final output data 102 is received.

Subsequently, the key-value store 10C stores the output data 102 into, for example, the memory 13 in the host apparatus 10 and delivers a completion response to the full backup command to the processor 14 (S10). Subsequently, the processor 14 writes the output data 102 stored in the memory 13, that is, the key-value data 102b of the backup target, as a file to the external recording medium 30 (S11). Accordingly, the key-value data 102b acquired from the storage apparatus 20 is stored as backup data into the external recording medium 30. At this time, the key-value data 102b of the backup target is preferably stored along with the same data structure as the data structure of the output data 102 into the external recording medium 30. In this way, the processor 14 completes the full backup operation.

In the above-described S11, the processor 14 may write the individual output data 102 corresponding to the buffer size 101d as an individual file to the external recording medium 30, or may generate one file in which the acquired plurality of pieces of the output data 102 corresponding to the buffer sizes 101d is collected and write this file to the external recording medium 30. In other words, the backup data corresponding to the buffer size 101d may each be generated in parallel to acquisition of the output data 102 corresponding to the buffer size 101d while executing the process of repeatedly executing the list command, or the list command may be repeatedly executed to acquire all the output data 102 until the termination and then generate the backup data. The plurality of pieces of output data 102 corresponding to buffer size 101d may be transmitted to and stored into an external system on a network as a stream.

1.2.2 Differential Backup Operation

Next, the differential backup operation in the storage system 1 according to the first embodiment will be described. The differential backup operation is an operation of storing (or copying) only the key-value data 102b updated from a certain time from the storage apparatus 20 to the external recording medium 30 (or the memory 13 of the host apparatus 10) as backup data after the full backup operation is executed.

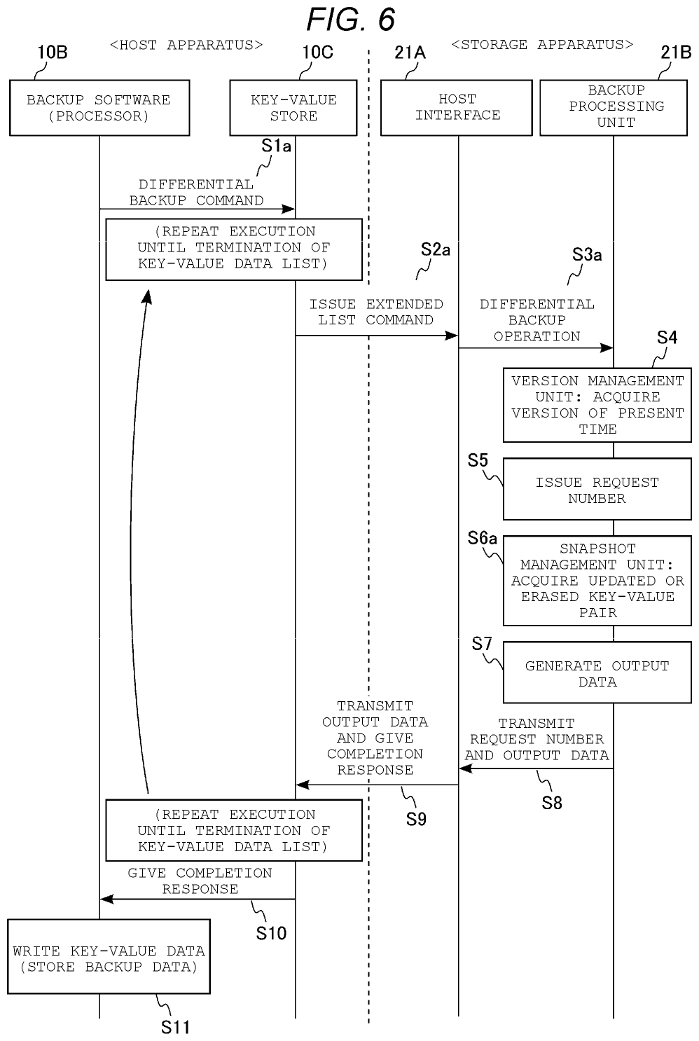

FIG. 6 is a sequence diagram illustrating operations, and transmission and reception of commands and signals between the host apparatus 10 and the storage apparatus 20 in the differential backup operation according to the first embodiment. Here, an example in which the backup data (the key-value data 102b) is stored into the external recording medium 30 will be described.

The processor 14 of the host apparatus 10 reads the backup software 10B and executes the following differential backup operation based on the backup software 10B.

In the differential backup operation, it is necessary to designate the version 101c serving as an origin point of the differential backup operation. Therefore, when the differential backup operation is requested, the full backup operation must have been performed earlier. Therefore, the processor 14 first sets the version 101c serving as the origin point of the differential backup operation in the version 101c acquired in the full backup operation executed once or more previously in the input data 101. Hereinafter, the version 101c serving as the origin point of the differential backup operation is also referred to as the version 101c of the origin point.

Subsequently, the processor 14 transmits a differential backup command to the key-value store 10C (Sla). The differential backup command is used to give a command to execute the differential backup operation to the key-value store 10C. With the differential backup command, similarly to the full backup command, the buffer address and the buffer size of the host apparatus 10 are designated.

When the differential backup command is received, the key-value store 10C issues the list command and the input data 101 to the storage apparatus 20 (S2a). As described above, the input data 101 includes the command type 101a, the request number 101b, the version 101c, the buffer size 101d, and the buffer address 101e.

Here, the command type 101a is set to a value indicating the differential backup operation. In the request number 101b, a predetermined initial value (for example, 0 or the like) is set in an initial stage of the differential backup operation. The version 101c is set in the version 101c of the origin point, as described above. The buffer address 101e and the buffer size 101d are similar to those of the full backup operation.

When the list command is received, the host interface 21A in the storage apparatus 20 gives a command to execute the differential backup operation to the backup processing unit 21B based on the received list command and the input data 101 (S3a).

The backup processing unit 21B generates the request number 101b and the version 101c based on the input data 101 similarly to the full backup operation. When the request number 101b is an initial value, the version management unit 21D acquires the version 101c of the present time at the start of the differential backup operation (S4) and the backup processing unit 21B further newly issues the request number 101b (S5). The backup processing unit 21B stores the version 101c of the present time and the issued request number 101b and further stores the version 101c of the origin point designated from the host apparatus 10 until the differential backup operation is completed.

Subsequently, the backup processing unit 21B supplies two versions 101c, that is, the version 101c of the present time and the version 101c of the origin point designated from the host apparatus 10 to the snapshot management unit 21E. The snapshot management unit 21E acquires the key-value pairs updated from the version 101c of the origin point to the version 101c of the present time (S6a). That is, the snapshot management unit 21E reads the key-value data 102b including the key-value pairs updated from the version 101c of the origin point to the version 101c of the present time from the storage unit 22. In the erased key-value data 102b, a value indicating invalidation is set in the valid flag 102ba of the key-value data 102b and 0 is set in the value size.

Subsequently, the backup processing unit 21B generates the output data 102 using the acquired key-value data 102b, the input data 101 received together with the list command, and the version 101c acquired in (S4) (S7). The backup processing unit 21B transmits the generated output data 102 and the request number 101b issued in (S5) to the host interface 21A (S8).

Thereafter, the same processes as those of (S9) to (S11) in the full backup operation are executed. In this way, the processor 14 completes the differential backup operation.

The processor 14 manages the version 101c of the present time of the differential backup operation provided in the output data 102 and the version 101c of the origin point of the full backup operation designated at the start of the differential backup operation as one pair of versions.

1.2.3 Restoring Operation

Next, the restoring operation in the storage system 1 according to the first embodiment will be described. The restoring operation is an operation of writing back the key-value data 102b stored as the backup data in the external recording medium 30 (or the memory 13 of the host apparatus 10) in the full backup operation or the differential backup operation from the external medium 30 (or the memory 13) to the storage apparatus 20. Here, an example in which the backup data (the key-value data 102b) is stored in the external recording medium 30 will be described. Hereinafter, the key-value data 102b stored in the external recording medium 30 in the full backup operation or the differential backup operation is referred to as the backup data.

The restoring operation of writing back the backup data stored in the external recording medium 30 in the full backup operation (hereinafter referred to as full backup data) is an operation of writing back the backup data to the storage apparatus 20 in which the key-value data 102b including the key-value pair is not stored. The restoring operation of writing back the backup data stored in the external recording medium 30 in the differential backup operation (hereinafter referred to as differential backup data) is the following operation. The restoring operation of writing back the differential backup data includes an operation of executing the restoring operation of writing back the full backup data with regard to the version 101c of the origin point acquired in the differential backup operation and then overwriting the differential backup data.

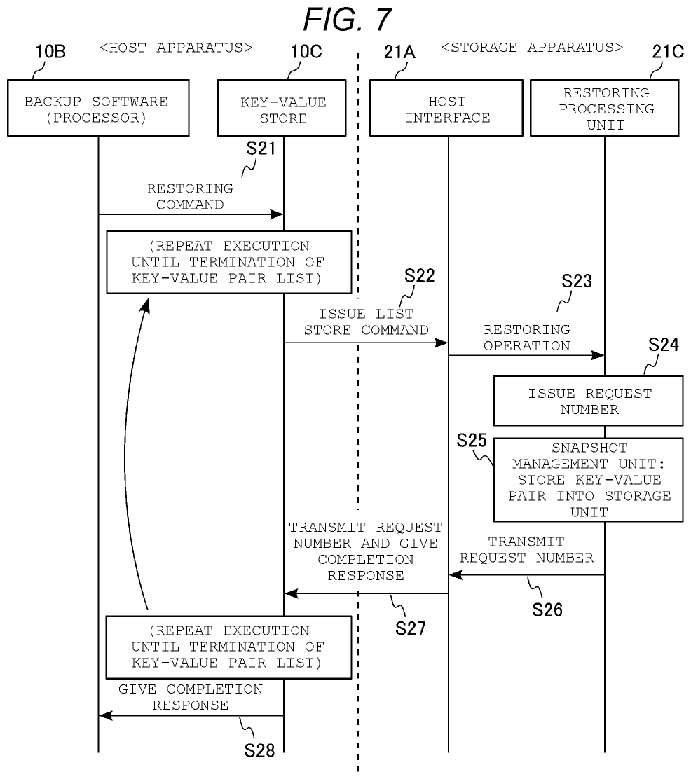

FIG. 7 is a sequence diagram illustrating operations, and transmission and reception of commands and signals between the host apparatus 10 and the storage apparatus 20 in the restoring operation according to the first embodiment. Here, it is assumed that the backup data (the key-value data 102b) is already read from the external recording medium 30 and the host apparatus 10 acquires the backup data. An example in which the backup data read from the external recording medium 30 is the full backup data will be described.

The processor 14 of the host apparatus 10 reads the backup software 10B and executes the following restoring operation based on the backup software 10B.

First, the processor 14 of the host apparatus 10 transmits a restoring command to the key-value store 10C (S21). With the restoring command, a command to execute the restoring operation is given to the key-value store 10C. The restoring command is further used to designate the backup data and the data size. The backup data is data that is read from the external recording medium 30 and include the key-value data 102b which is a restoring operation target (hereinafter referred to as a restoring target). The data size is a data size of the backup data including the key-value data 102b which is a restoring target.

When the restoring command is received, the key-value store 10C issues a list store command to the storage apparatus 20 (S22). Specifically, the key-value store 10C transmits the input data 201 including the restoring target to the storage apparatus 20 along with the list store command. The input data 201 includes the request number 201a, the data size 201b, and the backup data 201c. The request number 201a is set to a predetermined initial value (for example, 0 or the like) in an initial stage of the restoring operation. The backup data 201c is data that includes the restoring target (the key-value data 102b) transmitted along with the transmitted list store command. The data size 201b is a data size of the backup data 201c transmitted along with the list store command.

When the list store command is received, the host interface 21A in the storage apparatus 20 gives a command to execute a restoring operation to the restoring processing unit 21C based on the received list store command and input data 201 (S23).

The restoring processing unit 21C generates the request number 201a based on the input data 201. The restoring processing unit 21C newly issues the request number 201a when the request number 201a is an initial value (S24). Further, the restoring processing unit 21C supplies the received backup data 201c to the snapshot management unit 21E.

Subsequently, the snapshot management unit 21E writes the backup data 201c to the storage unit 22. That is, the snapshot management unit 21E receives a list of the key-value data 102b provided in the backup data 201c and stores the key-value data 102b including the key-value pairs into the storage unit 22 (S25). When the key-value data 102b is stored into the storage unit 22, the version management unit 21D issues the version 101c. The version 101c issued here is the version 101c that is not related to the version 101c provided in the backup data 201c and can be used in the storage apparatus 20 in the restoring operation.

Subsequently, the restoring processing unit 21C transmits the request number 201a issued in (S24) to the host interface 21A (S26). The host interface 21A transmits the received request number 201a to the key-value store 10C. After the transmission, the host interface 21A responds to the key-value store 10C with a completion response to the list store command (S27).

Here, a case is assumed in which, due to a relationship between a total data amount of the backup data 201c of the restoring target and a size of a buffer of the host apparatus 10, that is, a data amount which can be transmitted at a time from the host apparatus 10 to the storage apparatus 20, all the backup data 201c cannot be written to the storage apparatus 20 while the list store command is issued once. In this case, the list store command is repeatedly issued a plurality of times and the storage apparatus 20 executes writing in response to the list store command issued the plurality of times. That is, until all the backup data 201c of the restoring target is written to the storage apparatus 20, the above-described processes from S22 to S27 are repeatedly executed. At this time, in the input data 201 transmitted along with the list store command issued at a second time and later, the request number 201a transmitted along with the completion response to the previous list store command in (S27) is set.

Thereafter, when all the backup data 201c of the restoring target is written, the key-value store 10C responds to the processor 14 with the completion response to the restoring command (S28). When the completion response is received, the processor 14 discards the request number 201a and completes the restoring operation.

The backup data 201c also includes the key 102bc erased during the differential backup operation. Therefore, the snapshot management unit 21E determines with the valid flag 102ba whether the key 102bc or the key-value pair is valid or invalid. In the invalid case, the key 102bc or the key-value pair is erased. Since the key 102bc provided in the data acquired in the backup operation executed once is not duplicate in either the full backup operation or the differential backup operation, an order in which the backup data is written with the list store command may be any order.

1.3 Advantages of First Embodiment

According to the first embodiment, it is possible to provide the storage system capable of storing the key-value pairs as the backup data and writing back or restoring the key-value pairs stored as the backup data.

Hereinafter, problems when the key-value pairs are backed up in the key-value persistent storage apparatus storing the key-value pairs will be described.

As a backup method in a key-value persistent storage apparatus, includes a file system-like data management to keep track of data written by the host apparatus itself, or reading a list of key-value pairs using a list command in conformity with a key-value standard. However, a largest advantage of a key-value interface is that, by managing data with a key-value format in the key-value persistent storage apparatus, efficient management is enhanced without duplicate management of data in the host apparatus and the key-value persistent storage apparatus. Therefore, it is not desirable that the host apparatus manage data apart from the key-value persistent storage apparatus. In reading of the list of the key-value pairs with the list command in conformity with the key-value standard, whenever the list command is executed, key-value pairs which can be stored in a buffer of the host apparatus among all the key-value pairs stored in the key-value persistent storage apparatus at that time are merely read.

A first problem when the backup operation is executed with the list command in conformity with the key-value standard is that, content can be rewritten by updating the key-value pairs during an operation of the list of the key-value pairs, a return value is not guaranteed. That is, the updating operation has to be stopped completely when the key-value pairs in the key-value persistent storage apparatus at a specific time are backed up.

A second problem is that the backup data of all the key-value pairs is acquired at a time with the list command since there is only a method of reading all the key-value pairs. Therefore, if the difference between the backup data and the updated key-value pairs is to be retrieved later, the only way is to read all the key-value pairs again, compare them with the previous backup data, and extract the updated key-value pairs, and read and write amounts and a compaction processing amount are greater than the previous backup data.

A third problem is that a restoring method of writing back or restoring the key-value pairs to the key-value persistent storage apparatus from the backup data is not particularly set. Therefore, when the backup data is written back by acquiring the backup data with the list command, the key-value pairs are written again with the store command. Accordingly, there is a problem in efficiency of the restoring operation.

Hereinafter, advantages of the first embodiment will be described in detail.

In the configuration of the first embodiment, by using the list command and the backup operation according to the embodiment, it is possible to acquire all the key-value pairs at a specific time stored in the storage apparatus 20 as the backup data.

In the configuration of the first embodiment, the version of the key-value pairs of the backup target in the storage apparatus 20 is managed. Accordingly, the backup operation can be executed even while the storage system is operating, and thus an operation can be executed as a background process while an application such as a database is operating. The management of the version is management in which a state of the key-value data 102b at a certain specific time can be acquired by having a state of the key-value data 102b at a specific time as a version and designating the version at the certain specific time.

In the configuration of the first embodiment, data of a backup target acquired in the backup operation includes only the key-value pairs and the metadata. Therefore, when the backup operation is executed, an amount of data communicated between the host apparatus 10 and the storage apparatus 20 can be reduced. The same also applies to data of a restoring target used in the restoring operation, and thus an amount of data communicated between the host apparatus 10 and the storage apparatus 20 can be reduced.

In the configuration of the first embodiment, only the updated key-value pairs can be acquired from a time of the previous full backup operation to start of the differential backup operation by the differential backup operation. Therefore, a read amount of the key-value pairs at the time of the differential backup operation can be reduced more than a case in which all the key-value pairs at a specific time are read.

In the configuration of the first embodiment, the backup data can be collected and written to the storage apparatus 20 with the list store command to write back the backup data to the storage apparatus 20 in the restoring operation, and thus it is possible to improve efficiency of the restoring operation.

### 2. Second Embodiment

Next, a storage system according to a second embodiment will be described. In the second embodiment, an example in which, in the configuration of the snapshot management unit 21E provided in the key-value persistent storage apparatus, a backup operation including issuing of a list command and a restoring operation including issuing of a list store command are executed in a range of the key-value standard will be described. The list command and the list store command used in the second embodiment are commands defined in conformity with the key-value standard. In the second embodiment, differences from the first embodiment will be mainly described.

2.1 Configuration of Storage System

First, a configuration of a storage system according to the second embodiment will be described. In the above-described first embodiment, the example in which the storage apparatus 20 includes the backup processing unit 21B, the restoring processing unit 21C, the version management unit 21D, and the snapshot management 21E has been described. These units indicate examples of the functional blocks implementing the backup operation and the restoring operation irrespective of a type of storage and a detailed implementing method. In the second embodiment, configurations and operations for implementing the backup operation and the restoring operation in a processing layer of an SSD will be described.

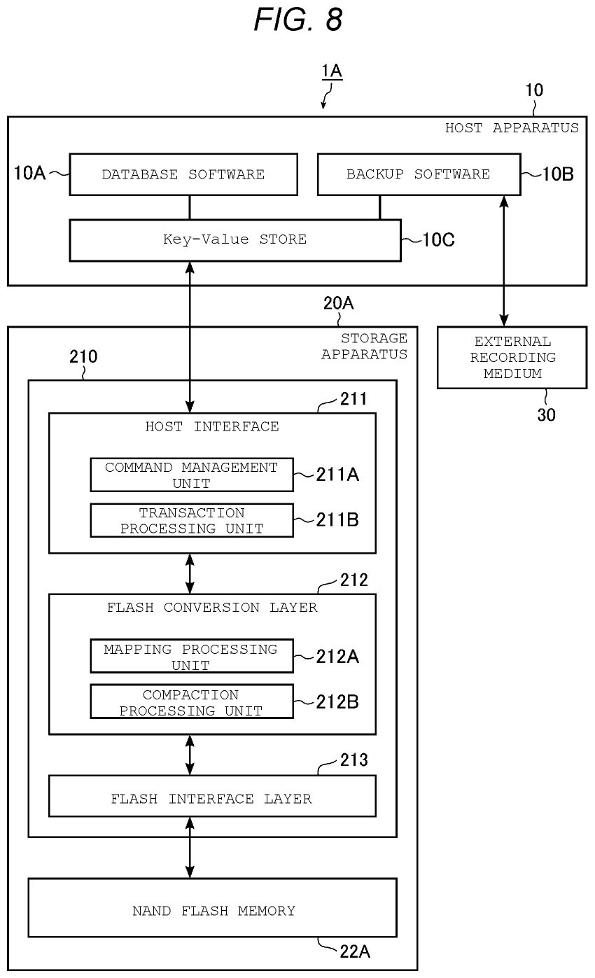

FIG. 8 is a block diagram illustrating a functional block of the storage system according to the second embodiment. The storage system 1A includes the host apparatus 10, a key-value persistent storage apparatus 20A, and the external recording medium 30. The host apparatus 10 includes the database software 10A, the backup software 10B, and the key-value store 10C. Hereinafter, the key-value persistent storage apparatus 20A is simply referred to as the storage apparatus 20A.

The storage apparatus 20A includes a memory controller 210, a NAND flash memory 22A (hereinafter referred to as a flash memory 22A). The memory controller 210 includes a host interface 211, a flash conversion layer 212, and a flash interface layer 213.

The host interface 211 includes a command management unit 211A and a transaction processing unit 211B. The command management unit 211A manages a standardized normal management command and input/output (I/O) command, and a command used in the embodiment. The transaction processing unit 211B executes commands used in the embodiment. The host interface 211 supports functions of the snapshot management unit 21E and the backup processing unit 21B not supported in the key-value standard.

The flash conversion layer 212 includes a mapping processing unit 212A and a compaction processing unit 212B. The mapping processing unit 212A executes a snapshot operation of reading the key-value pairs from the flash memory 22A or writing the key-value pairs to the flash memory 22A. The compaction processing unit 212B executes an operation or the like of collecting valid data provided in a target storage region in the flash memory 22A and moving the valid data to another block.

The flash interface layer 213 is connected to the flash memory 22A via a memory bus to communicate with the flash memory 22A. The flash interface layer 213 transmits various signals, commands, and data to the flash memory 22A. The flash interface layer 213 also receives various signals and data from the flash memory 22A.

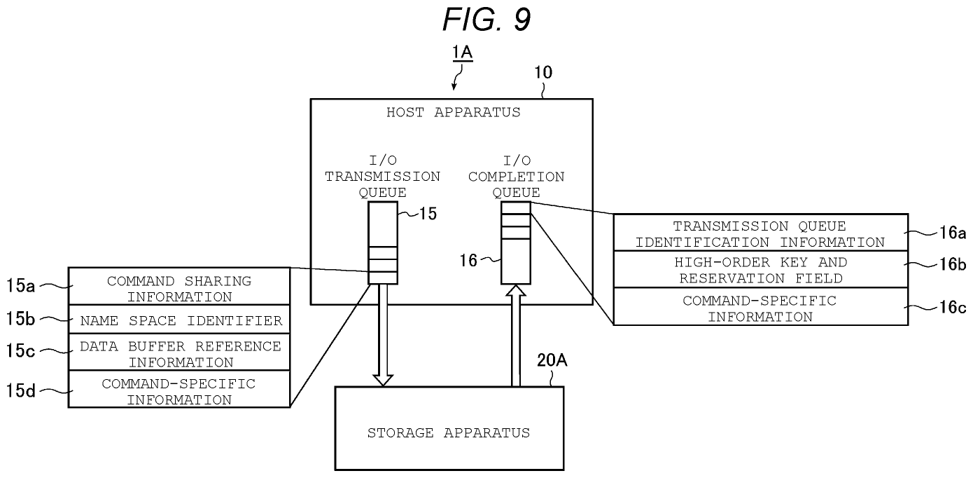

Next, a configuration example in which the host apparatus 10 and the storage apparatus 20A according to the second embodiment are connected in conformity with the PCI Express™ standard will be described. FIG. 9 is a block diagram illustrating a configuration example in which the host apparatus 10 and the storage apparatus 20A are connected in conformity with the PCI Express standard.

The host apparatus 10 executes input/output operations between the host apparatus 10 and the storage apparatus 20A using an input/output (I/O) transmission queue 15 and an input/output (I/O) completion queue 16.

Entries of the I/O transmission queue 15 include various types of information. The entries of the I/O transmission queue 15 include, for example, command sharing information 15a, a namespace identifier 15b, data buffer reference information 15c, and command-specific information 15d. In the embodiment, information regarding a request including a command from the host apparatus 10 to the storage apparatus 20A is stored in a reference destination indicating the data buffer reference information 15c. Accordingly, processing functions of commands in the backup operation, the restoring operation and the snapshot operation which are not supported in conformity with the key-value standard are implemented.

A result of an input/output operation from the storage apparatus 20A is stored as information into the I/O completion queue 16. The I/O completion queue 16 includes, for example, transmission queue identification information 16a, a high-order key and reservation field 16b, and command-specific information 16c. In the embodiment, a structure for making a plurality of requests at a time is implemented by using the high-order key and reservation field 16b in an operation in conformity with the key-value standard. The use of the high-order key and reservation field 16b is an example and a structure for making a plurality of requests at a time in accordance with a scheme of extending information fields or a method of using an asynchronous event notification may be implemented.

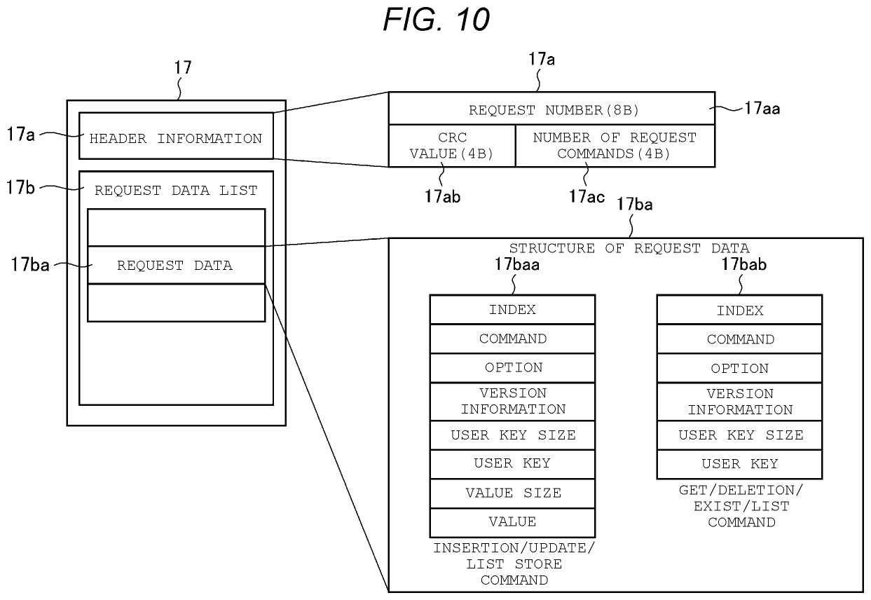

FIG. 10 illustrates an example of content of a request stored in a reference destination of the data buffer reference information 15c of the I/O transmission queue 15 when a request is issued from the host apparatus 10 to the storage apparatus 20A.

Content 17 of the request stored in the reference destination of the data buffer reference information 15c is content issued with one input/output request. A plurality of commands for making requests may be stored in the content 17 of the request.

The content 17 of the request includes header information 17a and a request data list 17b. The header information 17a includes a request number 17aa, a cyclic redundancy code (CRC value) 17ab, and the number of request commands 17ac. The request number 17aa is a value corresponding to the content 17 of the request and is used to specify the content 17 of the request. A data size of the request number 17aa is, for example, eight bytes. The cyclic redundancy code 17ab is a code for cyclic redundancy check of information in which the request number 17aa and the list 17b of request data are combined. A data size of the cyclic redundancy code 17ab is, for example, four bytes. Further, the number of request commands 17ac is the number of commands in which the content 17 of the request is included. A data size of the number of request commands 17ac is, for example, four bytes.

By setting a UNIX (registered trademark) time (a formal elapsed time from AM 00:00:00 Jan. 1, 1970 at a coordinated universal time) in the request number 17aa, it is possible to implement time management of a snapshot operation executed by the mapping processing unit 212A of the storage apparatus 20A. In the request number 17aa, a version in a simple snapshot operation may be designated. When the UNIX time is set in the request number 17aa and it is necessary to access a plurality of host apparatuses, a structure in which errors in the time of each host apparatus is taken into consideration is necessary.

In the list 17b of the request data, the request data 17ba is stored for each command. In the request data 17ba, two formats are prepared.

A first format is a format of a command with which it is necessary to hand over a value to the storage apparatus 20A in a request like an insertion command, an update command, or a list store command which is a command for storing data into the storage apparatus 20A. The first format includes information 17baa illustrated in FIG. 10.

A second format is a format of command with which it is not necessary to hand over a value to the storage apparatus 20A in a request like other commands, for example, a Get command, a deletion command, an Exist command, or a list command. The second format includes information 17bab illustrated in FIG. 10.

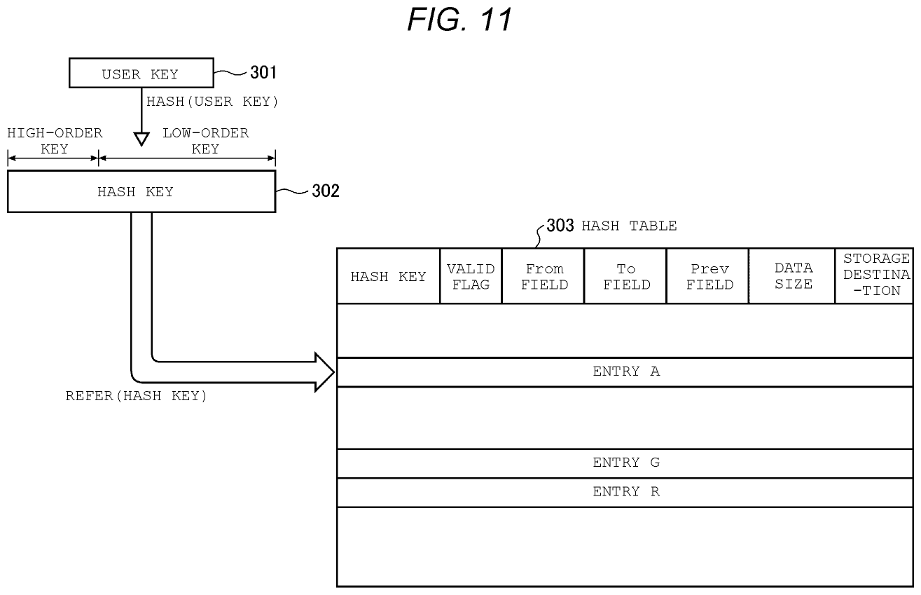

FIG. 11 illustrates a method in which the mapping processing unit executing a snapshot operation maps a user key and a data storage destination to the flash memory 22A. FIG. 11 illustrates an example in which a hash table is used.

The mapping processing unit 212A converts a user key 301 into a hash key 302 by a hash function. With the hash key 302 a reference destination of an entry shown in the hash table 303 is determined. Entries of the hash table 303 include a hash key, a valid flag indicating whether a value is a valid value, a From field and a To field indicating a version section of a storage destination, a Prev field indicating a position in a bucket in which an immediately previous version is stored, a data size, and a storage destination. The data size is a data size with which data can be stored. The storage destination is an address indicating a storage destination in the flash memory 22A.

It is difficult to store all data of the hash table 303 on a volatile memory in the storage apparatus 20A. Therefore, the data is divided in specific units, is managed in the flash memory 22A, and is read from the flash memory 22A to the volatile memory to be referred to as necessary.

It is general to use a method of storing the hash table 303 in a volatile memory for a given period of time without discarding the hash table 303 immediately after reference in order to optimize reading from the flash memory 22A.

When a snapshot operation is executed and version information is designated during reference to data, the mapping processing unit 212A refers to the From field and the To field in the hash table 303. When the data is not in a version range designated with the version information, a version such as an immediately previous version is checked with reference to the Prev field. At this time, when the valid flag is 0 in the designated version section, that is, the valid flag is invalid, it is indicated that erasing of the designated user key 301 is completed in the version. In this case, the mapping processing unit 212A processes the user key 301 as an erased state. When a version older than the stored oldest version is designated, it is assumed that the user key 301 is not stored.

When a new entry is stored, an entry of a key in which there are a plurality of oldest versions is erased in a stage in which the number of entries exceeds a predetermined number in the same bucket and the new entry is stored to maintain a given number in the bucket. At this time, since the backup operation is necessary for a key of a newest version among a version stored in the start of the backup operation and versions older than the version, the newest version is maintained without being erased. For timings at which the past versions are maintained and erased, a management mechanism such as a command controlled by the host apparatus 10 may be provided.

2.2 Operation of Storage System

A full backup operation, a differential backup operation, and a restoring operation in the storage system LA according to the second embodiment will be described.

2.2.1 Full Backup Operation

A full backup operation in the storage system LA according to the second embodiment will be described.

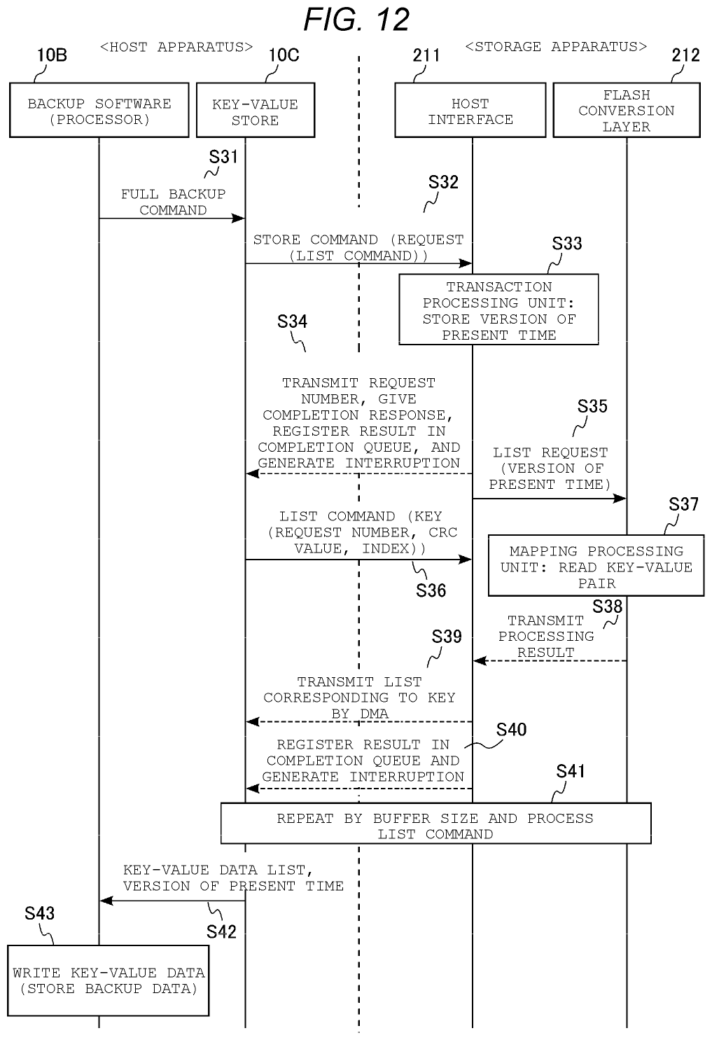

FIG. 12 is a sequence diagram illustrating operations, and transmission and reception of commands and signals between the host apparatus 10 and the storage apparatus 20A in the full backup operation according to the second embodiment. Here, an example in which the backup data (all the key-value data 102b stored in the storage apparatus 20A) is stored into the external recording medium 30 will be described.

The processor 14 of the host apparatus 10 reads the backup software 10B and executes the following full backup operation based on the backup software 10B.

The processor 14 of the host apparatus 10 transmits a full backup command to the key-value store 10C (S31). Subsequently, the key-value store 10C transmits a store command that includes the list command described in the first embodiment as a value and defined in conformity with the key-value standard to the host interface 211 of the storage apparatus 20A (S32). The list command included in the store command includes, for example, the information 17bab illustrated in FIG. 10.

When the store command is received, the transaction processing unit 211B in the host interface 211 newly issues the version 101c and stores the issued version as the version 101c of the present time (S33).

The host interface 211 responds to the key-value store 10C with a request number for specifying the list command as a completion response. The host interface 211 further registers a processing result of the store command in the I/O completion queue 16 and generates an interruption (S34).

The host interface 211 then sends a list request to the flash conversion layer 212 specifying the current version (S35).

When the completion response to the store command is received in (S34), the key-value store 10C transmits the list command in which the request number in the completion response is set as a key and which is defined in conformity with the key-value standard to the host interface 211 (S36). When the version of the present time is received with response to the list request in (S35), the mapping processing unit 212A in the flash conversion layer 212 of the storage apparatus 20A reads the key-value data 102b including the key-value pairs from the flash memory 22A and generates the list of the key-value data 102b (S37). The flash conversion layer 212 further transmits the processing result, that is, the list of the key-value data 102b, to the host interface 211 (S38).

Subsequently, the host interface 211 transmits the list of the received key-value data 102b to a storage destination of the host apparatus 10 indicated by the list command in S36, for example, the memory 13, by direct memory access (DMA) (S39).

Subsequently, the host interface 211 responds to the key-value store 10C with a completion response to the list command. The host interface 211 further registers the processing result of the list command in the I/O completion queue 16 and generates an interruption (S40).

Thereafter, the key-value store 10C repeatedly issues the list instruction and obtains the list of key-value data 102b corresponding to the buffer size prepared by the key-value store 10C, and acquires the list of all the key-value data 102b of the full backup target (S41).

Subsequently, the key-value store 10C transmits the receive data, that is, the list of the key-value data 102b and the version of the present time, to the processor 14 (S42).

Subsequently, the processor 14 writes the key-value data 102b stored in the memory 13 as a file to the external recording medium 30 (S43). Accordingly, the key-value data 102b is stored as backup data into the external recording medium 30. In this way, the processor 14 completes the full backup operation.

In the example illustrated in FIG. 12, the sequence in which the processor 14 operating in accordance with the backup software acquires all the key-value data 102b of the backup target with the full backup command issued once has been described. However, the processor 14 may determine termination from an output result with the list command, repeatedly execute the full backup command, receive and store the backup data in units of the list commands.

2.2.2 Differential Backup Operation

Next, the differential backup operation in the storage system 1A according to the second embodiment will be described.

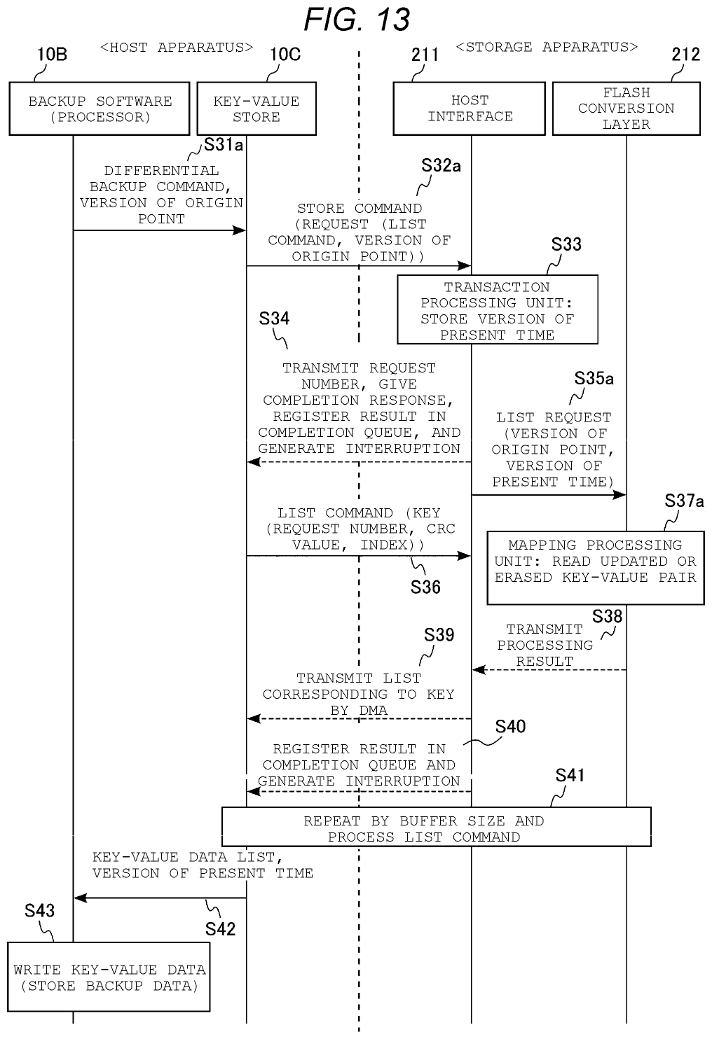

FIG. 13 is a sequence diagram illustrating operations, and transmission and reception of commands and signals between the host apparatus 10 and the storage apparatus 20A in the differential backup operation according to the second embodiment. Here, an example in which the backup data (part of the key-value data 102b stored in the storage apparatus 20A) is stored into the external recording medium 30 will be described.

The processor 14 of the host apparatus 10 reads the backup software 10B and executes the following differential backup operation based on the backup software 10B.

In the differential backup operation, the processor 14 of the host apparatus 10 selects a version of an origin point of the differential backup operation among the versions acquired in the full backup operation executed once or more previously. The processor 14 transmits the differential backup command and the selected version 101c of the origin point to the key-value store 10C (S31a).

Subsequently, the key-value store 10C transmits the store command includes the list command mentioned in the first embodiment as a value and defined in the key-value standard and the version of the origin point to the host interface 211 of the storage apparatus 20A (S32a). The list command provided in the store command includes, for example, the information 17bab illustrated in FIG. 10.

When the store command is received, the transaction processing unit 211B in the host interface 211 newly issues the version 101c and stores the issued version as the version 101c of the present time (S33).

The host interface 211 responds to the key-value store 10C with the request number for specifying the list command as the completion response. The host interface 211 further registers the processing result of the store command in the I/O completion queue 16 and generates an interruption (S34).

Thereafter, the host interface 211 transmits the list request in which the version of the origin point and the version of the present time are designated to the flash conversion layer 212 (S35a).

When the completion response to the store command is received in (S34), the key-value store 10C transmits the list command in which the request number in the completion response is set as a key and which is defined in conformity with the key-value standard to the host interface 211 (S36). When the version of the present time is received with response to the list request in (S35), the mapping processing unit 212A in the flash conversion layer 212 of the storage apparatus 20A reads the key-value data 102b including the key-value pairs updated from the version of the origin point of the full backup operation to the version of the present time in the differential backup operation from the flash memory 22A, and generates the list of the key-value data 102b (S37a). The flash conversion layer 212 further transmits the processing result, that is, the list of the key-value data 102b, to the host interface 211 (S38). In the erased key-value data 102b, a value indicating invalidity is set in the valid flag of the key-value data 102b and 0 is set in the value size.

The subsequent differential backup operation is similar to the above-described full backup operation. In this way, the processor 14 completes the differential backup operation.

2.2.3 Restoring Operation

Next, the restoring operation in the storage system LA according to the second embodiment will be described.

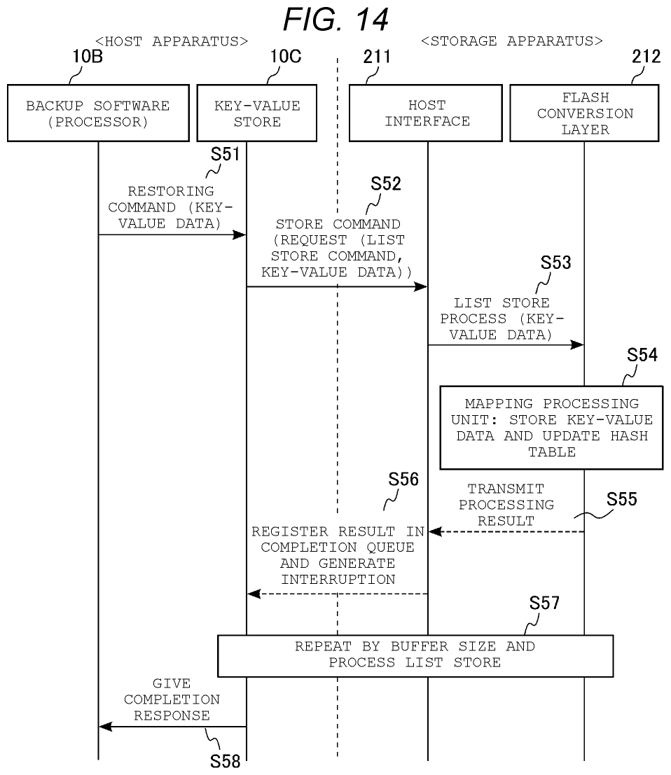

FIG. 14 is a sequence diagram illustrating operations, and transmission and reception of commands and signals between the host apparatus 10 and the storage apparatus 20A in the restoring operation according to the second embodiment.

The processor 14 of the host apparatus 10 reads the backup software 10B and executes the following restoring operation based on the backup software 10B.

The processor 14 of the host apparatus 10 transmits the restoring command and the key-value data 102b of a restoring target to the key-value store 10C (S51). Subsequently, the key-value store 10C transmits the store command includes the list store command described in the first embodiment as a value and defined in conformity with the key-value standard and the key-value data 102b to the host interface 211 of the storage apparatus 20A (S52). The list store command included in the store command includes, for example, the information 17baa illustrated in FIG. 10. The key-value data 102b transmitted from the key-value store 10C has a data size with which data can be transmitted from the host apparatus 10 to the storage apparatus 20A with one list store command.

When the store command is received, the host interface 211 executes the list store process with the list store command. The host interface 211 further transmits the received key-value data 102b to the flash conversion layer 212 (S53).

Subsequently, the mapping processing unit 212A in the flash conversion layer 212 writes the key-value data 102b to the flash memory 22A. That is, the mapping processing unit 212A stores the key-value data 102b including the key-value pairs into the flash memory 22A. Further, the flash conversion layer 212 updates the storage destination of the data stored in the hash table 303 (S54). Thereafter, the flash conversion layer 212 transmits the processing result to the host interface 211 (S55).

Subsequently, the host interface 211 responds to the key-value store 10C with the completion response to the store command. The host interface 211 further registers the processing result of the store command in the I/O queue 16 and generates an interruption (S56).

Here, when all the key-value data 102b of the restoring target cannot be written in once executed issuing of the list store command, the key-value store 10C repeatedly issues the store command including the list store command a plurality of times and writes the key-value data 102b corresponding to the buffer size to the storage apparatus 20A. That is, until all the key-value data 102b of the restoring target is written to the storage apparatus 20A, the above-described processes from S52 to S56 are repeatedly executed (S57).

Thereafter, the key-value store 10C responds to the processor 14 with the completion response to the restoring command (S58). In this way, the processor 14 completes the restoring operation.

In the example illustrated in FIG. 14, the sequence in which the processor 14 operating in accordance with the backup software writes all the key-value data 102b of the restoring target to the flash memory 22A with the restoring command issued once has been described. However, instead of repeatedly executing the processes from S52 to S56, the processor 14 may repeatedly execute the restoring command by determining a termination flag of the key-value data 102b provided in the backup data.

2.3 Advantages of Second Embodiment

According to the second embodiment, it is possible to provide the storage system capable of storing the key-value pairs as the backup data and writing back or restoring the key-value pairs stored as the backup data in conformity with the key-value standard.

Further, in the configuration of the second embodiment, by providing the extended list command or the list store command as the value of the store command, it is possible to operate the backup operation and the restoring operation using the interface in conformity with the key-value standard.

In the configuration of the second embodiment, since the versions can be managed with the hash table 303, access to the key-value pairs of the plurality of versions can be made quickly. The other advantages are similar to those of the first embodiment.

### 3. Third Embodiment

Next, a storage system according to a third embodiment will be described. In the third embodiment, the host apparatus 10 accesses the key-value persistent storage apparatus without being involved in the key-value store 10C and executes the backup operation and the restoring operation in accordance with the backup software. The host apparatus 10 is similar to that of the first embodiment except for the configuration and the operation related to the direct issuing of the command in accordance with the backup software. In the third embodiment differences from the first embodiment will be mainly described.

3.1 Configuration of Storage System

First, a configuration of a storage system according to the third embodiment will be described.

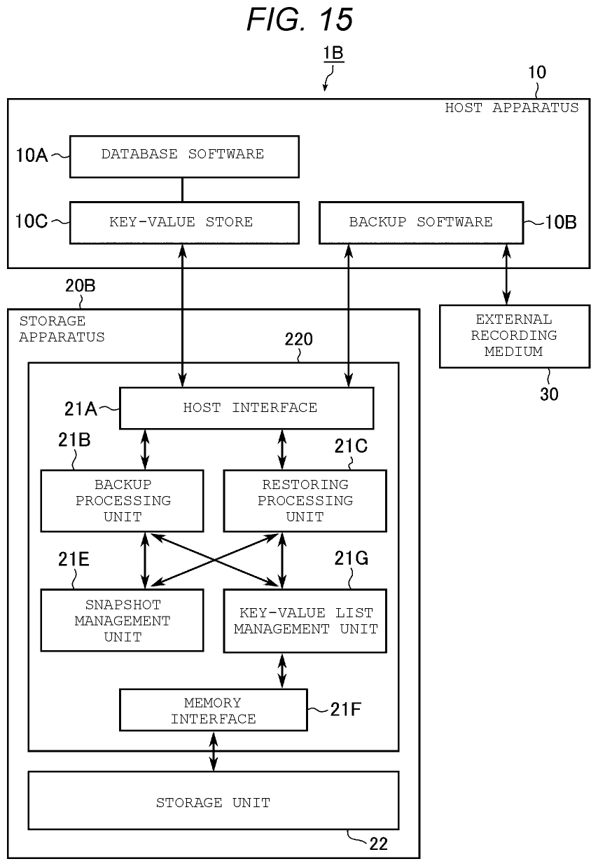

FIG. 15 is a diagram illustrating a functional block of the storage system according to the third embodiment. A storage system 1B includes the host apparatus 10, a key-value persistent storage apparatus 20B, and the external recording medium 30. The host apparatus 10 includes the database software 10A, the backup software 10B, and the key-value store 10C. Hereinafter, the key-value persistent storage apparatus 20B is simply referred to as the storage apparatus 20B.

The storage apparatus 20B includes a memory controller 220 and a storage unit 22. The memory controller 220 includes the host interface 21A, a backup processing unit 21B, a restoring processing unit 21C, the snapshot management unit 21E, a key-value list management unit 21G, and the memory interface 21F. The key-value list management unit 21G manages the list of the key-value data 102b. The other configurations are similar to those of the first embodiment.

3.2 Operation of Storage System

A full backup operation, a differential backup operation, and a restoring operation in the storage system 1B according to the third embodiment will be described.

3.2.1 Full Backup Operation

The full backup operation in the storage system 1B according to the third embodiment will be described.

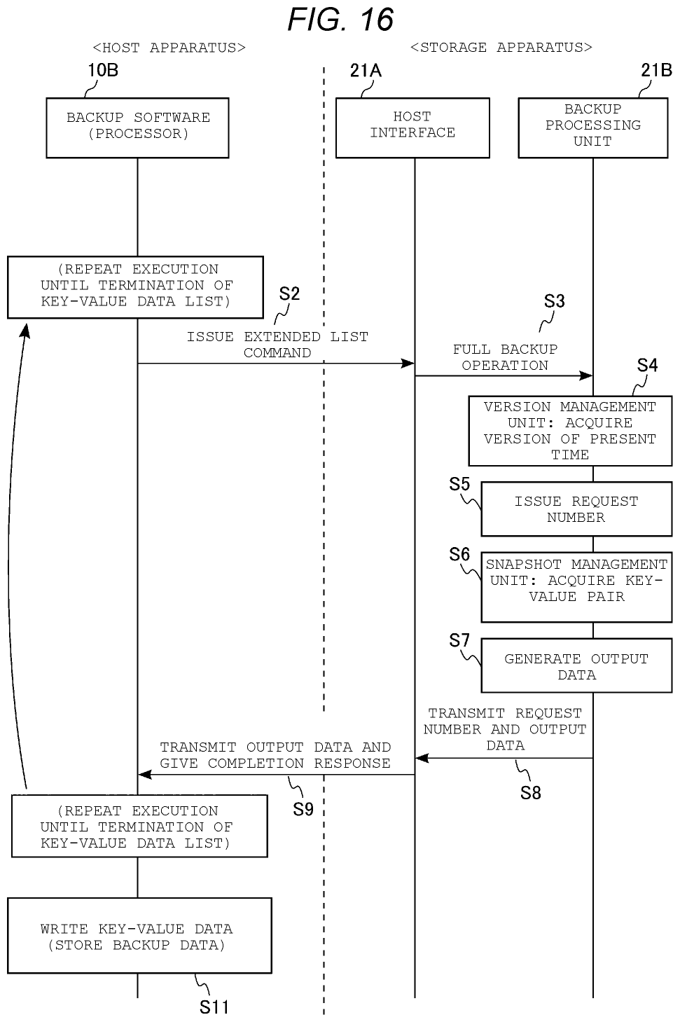

FIG. 16 is a sequence diagram illustrating operations, and transmission and reception of commands and signals between the host apparatus 10 and a persistent storage apparatus 20B in the full backup operation according to the third embodiment.

The processor 14 of the host apparatus 10 reads the backup software 10B and executes the following full backup operation based on the backup software 10B.

The processor 14 of the host apparatus 10 issues the input data 101 illustrated in FIG. 3 to the storage apparatus 20B along with the list command in accordance with the backup software 10B (S2).

When the list command is received, the storage apparatus 20B executes processes similar to the processes from S3 to S8 of FIG. 5.

After the process of (S8), the host interface 21A of the storage apparatus 20 sets a transmission destination in the buffer address 101e and transmits the output data 102 to the processor 14. After the transmission, the host interface 21A responds to the processor 14 with the completion response to the list command (S9). The completion response includes the stored request number 101b.

After the completion response is received, the processor 14 of the host apparatus 10 checks the termination flag 102ab in the output data 102 and determines whether the received output data 102 is the last output data.

When the output data 102 is not the last output data, the processor 14 repeatedly executes the above-described processes from S2 to S9 until the last output data 102 is received, that is, the output data 102 in which a value indicating end is set in the termination flag 102ab is received.

Subsequently, the processor 14 stores the output data 102 into, for example, the memory 13 in the host apparatus 10. Subsequently, the processor 14 writes the output data 102 stored in the memory 13, that is, the key-value data 102b of the backup target, as a file to the external recording medium 30 (S11). Accordingly, the key-value data 102b acquired from the storage apparatus 20 is stored as backup data into the external recording medium 30. In this way, the processor 14 completes the full backup operation. The other operations are similar to those of the first embodiment.

3.2.2 Differential Backup Operation

Next, the differential backup operation in the storage system 1B according to the third embodiment will be described.

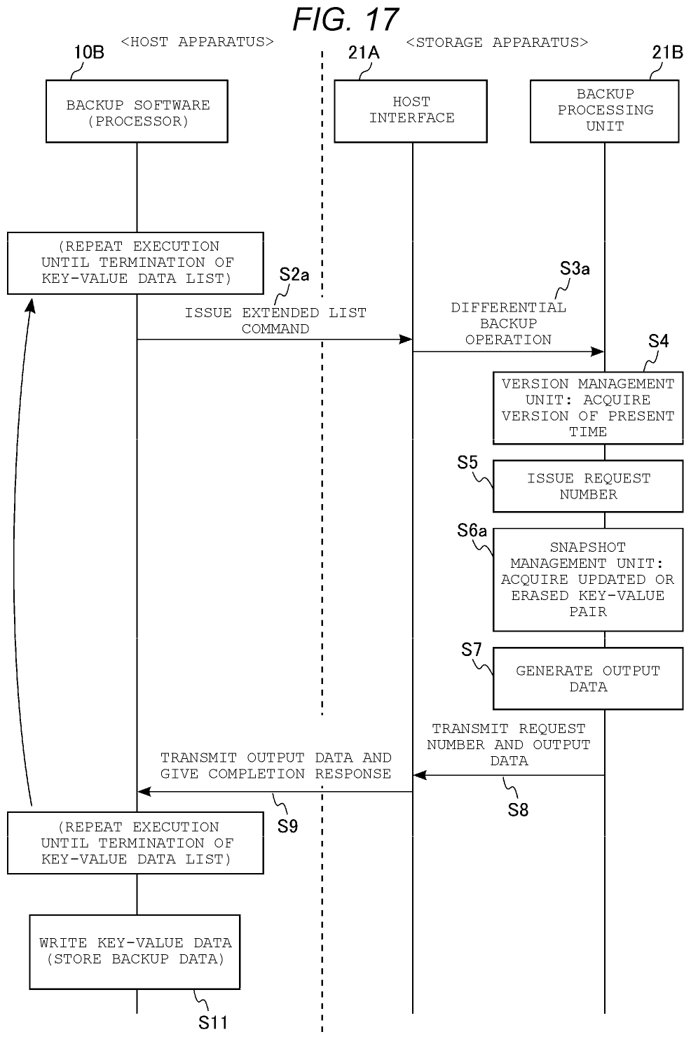

FIG. 17 is a sequence diagram illustrating operations, and transmission and reception of commands and signals between the host apparatus 10 and the storage apparatus 20B in the differential backup operation according to the third embodiment.

The processor 14 of the host apparatus 10 reads the backup software 10B and executes the following differential backup operation based on the backup software 10B.

First, the processor 14 of the host apparatus 10 sets the version 101c serving as an origin point of the differential backup operation among the versions 101c provided in the output data 102 acquired in the full backup operation executed one or more previously in the input data 101.

Subsequently, the processor 14 issues the input data 101 illustrated in FIG. 3 to the storage apparatus 20B along with the list command (S2a).

When the list command is received, the storage apparatus 20B executes processes similar to the processes from S3a to S8 of FIG. 6.

Thereafter, processes similar to the processes from S9 to S11 in the full backup operation according to the third embodiment illustrated in FIG. 16 are executed. In this way, the processor 14 completes the differential backup operation. The other operations are similar to those of the first embodiment.

3.2.3 Restoring Operation

Next, the restoring operation in the storage system 1B according to the third embodiment will be described.

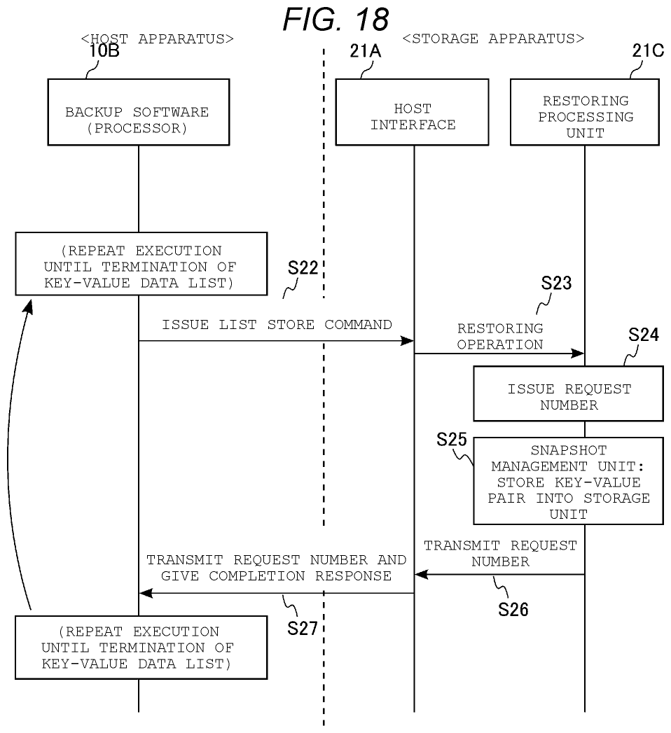

FIG. 18 is a sequence diagram illustrating operations, and transmission and reception of commands and signals between the host apparatus 10 and the storage apparatus 20B in the restoring operation according to the third embodiment. Here, it is assumed that the backup data (the key-value data 102b) is already read from the external recording medium 30 and the host apparatus 10 acquires the backup data. An example in which the backup data read from the external recording medium 30 is the full backup data will be described.

The processor 14 of the host apparatus 10 reads the backup software 10B and executes the following restoring operation based on the backup software 10B.

First, the processor 14 of the host apparatus 10 issues the input data 201 to the storage apparatus 20B along with the list store command (S22).

When the list store command is received, the storage apparatus 20B executes processes similar to the processes from S23 to S26 of FIG. 7. Subsequently, the host interface 21A of the storage apparatus 20B transmits the received request number 201a to the processor 14. After the transmission, the host interface 21A responds to the processor 14 with the completion response to the list store command (S27).

Here, when all the backup data 201c cannot be written to the storage apparatus 20B in the once executed issuing of the list store command, the list store command is repeatedly issued a plurality of times and the storage apparatus 20B executes writing in response to the list store commands issued the plurality of times. That is, until all the backup data 201c of the restoring target is written to the storage apparatus 20B, the above-described processes from S22 to S27 are repeatedly executed.

Subsequently, the processor 14 discards the request number 201a and completes the restoring operation. The other operations are similar to those of the first embodiment.

3.3 Advantages of Third Embodiment

According to the third embodiment, it is possible to provide the storage system capable of storing the key-value pairs as the backup data and writing back or restoring the key-value pairs stored as the backup data.

Further, in the configuration of the third embodiment, since the storage apparatus 20B has the function of executing the backup operation and the restoring operation, the processor 14 directly issues the command to the host interface 21A of the storage apparatus 20B without being involved in the key-value store 10C, acquires the key-value data 102b of a backup target, and stores the key-value data 102b into the external recording medium 30. Accordingly, the key-value data 102b stored in the storage apparatus 20B can be stored efficiently as the backup data into the external recording medium 30.

In the configuration of the third embodiment, the processor 14 operating based on the backup software 10B can directly access the storage apparatus 20B irrespective of the database or the key-value store in the host apparatus 10 and execute the backup operation and the restoring operation. Accordingly, for example, when the storage apparatus 20B is connected to a fabric network, a large-scale apparatus and software are not prepared and the backup operation and the restoring operation can be executed without being involved in the host apparatus. The other advantages are similar to those of the first embodiment.

### 4. Fourth Embodiment

Next, a storage system according to a fourth embodiment will be described. In the fourth embodiment, an example of a sequence of a restoring operation different from the restoring operation in the second embodiment will be described. In the fourth embodiment, as in the third embodiment, the processor 14 of the host apparatus 10 directly accesses the key-value persistent storage apparatus without being involved in the key-value store 10C in accordance with the backup software. Specifically, in the fourth embodiment, when the restoring operation is executed based on the backup software, the processor 14 does not execute the list store command with respect to the host interface 21A and parses the key-value data 102b of a restoring target in accordance with the backup software. The commands corresponding to an insertion process for the key-value pairs provided in the key-value data 102b and the deletion process are executed as a transaction process. The transaction processing unit executes the insertion process and the deletion process for the request list. In the fourth embodiment, differences from the second embodiment will be mainly described.

4.1 Configuration of Storage System

Since a configuration of the storage system 1 according to the fourth embodiment is similar to that of the second embodiment, description thereof will be omitted.

4.2 Operation of Storage System

A restoring operation in the storage system 1 according to the fourth embodiment will be described.

4.2.1 Restoring Operation

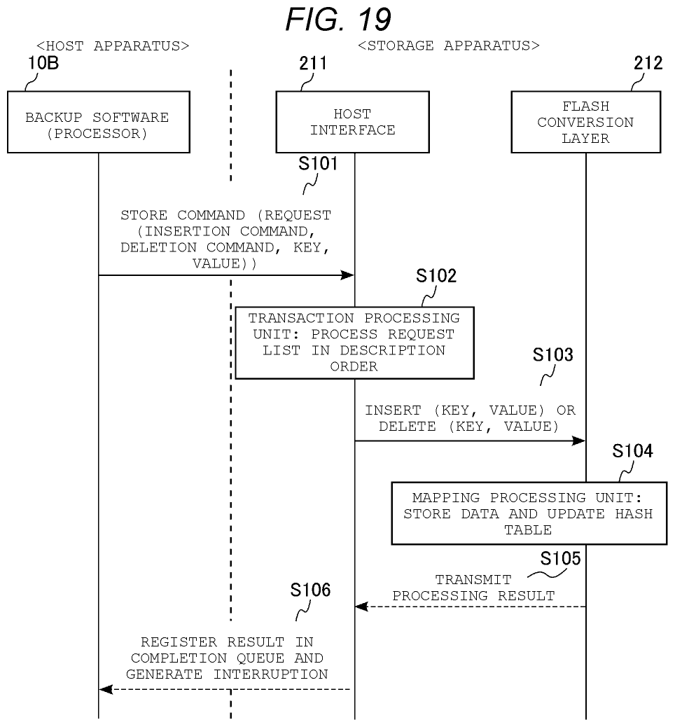

FIG. 19 is a sequence diagram illustrating operations, and transmission and reception of commands and signals between the host apparatus 10 and the storage apparatus 20 in a restoring operation according to the fourth embodiment. Here, it is assumed that the backup data (the key-value data 102b) is already read from the external recording medium 30 and the host apparatus 10 acquires the backup data. The backup data read from the external recording medium 30 is the full backup data.

The processor 14 of the host apparatus 10 reads the backup software 10B and executes the following restoring operation based on the backup software 10B.

First, the processor 14 of the host apparatus 10 parses the backup data of a restoring target based on the backup software 10B. That is, the processor 14 converts the backup data into data with a data structure which can be handled in the insertion process and the deletion process. Hereinafter, the converted backup data is referred to as converted key-value data.

The processor 14 transmits a request list as a store command to the host interface 21A (S101). The request list includes an insertion command, a deletion command, and conversion key-value data. The insertion command is a command corresponding to the insertion process and is a command to write data. The deletion command is a command corresponding to the deletion process and is a command to delete data.

Subsequently, the transaction processing unit 211B processes the insertion command and the deletion command of the request list in order (S102). Specifically, the insertion process and the deletion process are executed on the converted key-value data to correspond to the flash conversion layer 212 and obtained data is transmitted to the flash conversion layer 212 (S103).

Subsequently, the flash conversion layer 212 writes data obtained in S103 by the mapping processing unit 212A to the storage unit 22. That is, the mapping processing unit 212A stores the data obtained in S103 into the storage unit 22. Further, the flash conversion layer 212 updates a storage destination of the data stored in the hash table 303 (S104). Further, the flash conversion layer 212 transmits the processing result to the host interface 21A (S105).

Thereafter, the processes from S102 to S105 are executed on all the converted key-value data described in the request list. When the process for the last converted key-value data ends, a processing result is transmitted to the processor 14. The processor 14 registers the received processing result in the I/O completion queue 16 and generates an interruption (S106). In this way, the restoring operation ends.

4.3 Advantages of Fourth Embodiment

According to the fourth embodiment, it is possible to provide the storage system capable of writing back the backed-up key-value pairs.

Further, in the configuration of the fourth embodiment, the number of request commands viewed in terms of the host interface 211 increases more than the list store command. However, a transaction request in accordance with the command transmission method described in the second embodiment is used, and thus the list store command is not necessary in the process of the storage apparatus 20 without a considerable increase in the number of times data transmitted between the host apparatus 10 and the storage apparatus 20. Therefore, it is possible to implement the restoring operation without changing a present system as much as possible. The other advantages are similar to those of the first embodiment.

### 5. Other Modifications

In the foregoing embodiments, the examples in which the storage apparatus 20 includes the NAND flash memory as the storage unit 22 have been described, but embodiments of the present disclosure are not limited to the NAND flash memory. The embodiments is also applicable to cases in which other semiconductor memories or various storage apparatuses other than the semiconductor memories are provided.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A storage system comprising:
a storage apparatus including:
a storage circuit configured to store first key-value data including a key-value pair which has a key and a value associated with the key; and
a controller configured to control the storage circuit; and
a host apparatus connected to the storage apparatus and a recording medium;
wherein the host apparatus is configured to transmit a first command and first input data including first information to the controller,
wherein the controller is configured to, in response to reception of the first command,
update the first information to generate second information, the second information being associated with the first key-value data,
read the first key-value data from the storage circuit,
generate first output data including the read first key-value data and the generated second information, and
transmit the first output data to the host apparatus, and
wherein the host apparatus is further configured to store the first output data into the recording medium.

2. The storage system according to claim 1,
wherein the controller is further configured to generate the second information and subsequently store an updated first key-value data into the storage circuit,
wherein the host apparatus is further configured to transmit a second command and second input data including the second information to the controller,
wherein the controller is further configured to, in response to reception of the second command,
generate third information different from the second information,
acquire second key-value data, the second key-value data being the updated first key-value data among the new first key-value data stored in the storage circuit from acquisition of the first key-value data associated with the second information to generation of the third information,
generate second output data including the second key-value data and the third information, and
transmit the second output data to the host apparatus, and
wherein the host apparatus is further configured to store the second output data into the recording medium in association with the second information and the third information.

3. The storage system according to claim 2, wherein the controller is further configured to acquire the first key-value data associated with the second information when the second command the second information are received.

4. The storage system according to claim 1,
wherein the controller is further configured to generate a first flag provided in the first output data, and
wherein, when the first output data is received, the host apparatus is further configured to:
repeat an operation of transmitting the first command and the first input data to the controller when the first flag is a first value, and
stop the operation of the transmitting the first command and the first input data to the controller when the first flag is not the first value.

5. The storage system according to claim 4,
wherein the first input data includes a first request number, and
wherein the controller is further configured to, in response to reception of the first input data,
update the first request number to generate a second request number,
transmit the first output data including the second request number to the host apparatus, and
acknowledge the first command in the repetition of the operation when the first command and the first input data including the second request number are received.

6. The storage system according to claim 1,
wherein the host apparatus includes a buffer,
wherein the first input data includes a buffer size and a buffer address,
wherein the buffer size indicates a storage capacity of the buffer, and
wherein the buffer address indicates an address of the buffer storing the first output data received from the controller.

7. The storage system according to claim 1, wherein the first input data includes a value indicating a command type.

8. The storage system according to claim 1,
wherein the host apparatus is further configured to:
read the first key-value data and the second information from the recording medium, and
transmit a third command, the first key-value data, and the second information to the controller, and
wherein the controller is further configured to, in response to reception of the third command,
write the first key-value data and the second information to the storage circuit.

9. The storage system according to claim 8,
wherein the storage apparatus is further configured to store a first flag associated with the first key-value data, and
wherein the host apparatus is further configured to read the first flag along with the first key-value data and the second information from the recording medium, and
wherein the host apparatus is further configured to, when the first flag is transmitted to the controller along with the third command, the first key-value data, and the second information,
repeat an operation of transmitting the third command, the first key-value data, the second information, and the first flag to the controller when the first flag is a first value, and
stop transmitting the third command, the first key-value data, the second information, and the first flag to the controller when the first flag is not the first value.

10. The storage system according to claim 1, wherein the storage circuit includes a NAND flash memory.

11. A storage apparatus comprising:
a storage circuit configured to store first key-value data including a key-value pair which has a key and a value associated with the key; and
a controller configured to control the storage circuit,
wherein the controller is configured to:
receive a first command and first input data including first information,
in response to reception of the first command, update the first information to generate second information, the second information being associated with the first key-value data,
read the first key-value data from the storage circuit,
generate first output data including the first key-value data and the second information, and
output the first output data.

12. The storage apparatus according to claim 11,
wherein the controller is further configured to generate the second information and subsequently store an updated first key-value data into the storage circuit, and
wherein the controller is further configured to:
receive a second command and second input data including the second information,
update the second information to generate third information in response to reception of the second command,
acquire second key-value data, the second key-value data being the updated first key-value data among the new first key-value data stored in the storage circuit from acquisition of the first key-value data associated with the second information to generation of the third information,
generate second output data including the second key-value data and the third information, and
output the second output data.

13. The storage apparatus according to claim 11, wherein the controller is further configured to:
receive a third command, the first key-value data, and the second information associated with the first key-value data, and
in response to reception of the third command, write the first key-value data and the second information to the storage circuit.

14. The storage apparatus according to claim 11, wherein the storage circuit includes a NAND flash memory.

15. A storage method of backing up, in a storage apparatus, first key-value data which is stored in the storage apparatus and includes a key-value pair, the key-value pair having a key and a value associated with the key, the method comprising:
receiving a first command and first input data including first information by the storage apparatus;
updating the first information to generate second information in response to the first command, the second information being associated with the first key-value data;
reading the first key-value data from the storage apparatus;
generating first output data including the first key-value data and the second information; and
outputting the first output data from the storage apparatus.

16. The storage method according to claim 15, further comprising:
storing an updated first key-value data into the storage apparatus after generating the second information;
receiving a second command and second data including the second information by the storage apparatus;
updating the second information to generate third information in response to reception of the second command;
acquiring second key-value data, the key-value data being the updated first key-value data among the new first key-value data stored in the storage circuit from acquisition of the first key-value data associated with the second information to generation of the third information;
generating second output data including the second key-value data and the third information; and
outputting the second output data from the storage apparatus.

17. The storage method according to claim 15, further comprising:
reading the first key-value data and the second information associated with the first key-value data from the storage apparatus;
receiving a third command, the first key-value data, and the second information by the storage apparatus; and
writing the first key-value data and the second information into the storage apparatus in response to reception of the third command.

18. The storage method according to claim 15, wherein the first input data includes a value indicating a command type.
